(19) United States
(12) Patent Application Publication
(10) Pub. No.: US 2025/0171014 A1
(43) Pub. Date: May 29, 2025

(54) PARKING ASSISTANCE DEVICE

(71) Applicant: Panasonic Automotive Systems Co., Ltd., Kanagawa (JP)

(72) Inventor: Yoshimasa OKABE, Kanagawa Ken (JP)

(73) Assignee: Panasonic Automotive Systems Co., Ltd., Kanagawa (JP)

(21) Appl. No.: 18/904,727

(22) Filed: Oct. 2, 2024

(30) Foreign Application Priority Data
Nov. 24, 2023 (JP) 2023-199101

(51) Int. Cl. B60W 30/06; B60W 30/182; B60W 50/08; B60W 50/14; B60W 60/00

(52) U.S. Cl. CPC B60W 30/06; B60W 30/182; B60W 50/082; B60W 50/14; B60W 60/0011; B60W 60/005; B60W 2050/146; B60W 2540/215; B60W 2556/40

(57) ABSTRACT

A parking assistance device is disclosed. The parking assistance device includes processing circuitry connected to a memory. The processing circuitry registers, during learning travel, a map including multiple routes from one parking start position to multiple parking positions. The processing circuitry causes, during automatic parking, a vehicle to perform autonomous travel based on the map. The processing circuitry selects, during automatic parking, a route on which the vehicle is to travel from among the multiple routes.

### CROSS-REFERENCE TO RELATED APPLICATIONS

This application is based upon and claims the benefit of priority from Japanese Patent Application No. 2023-199101, filed on Nov. 24, 2023, the entire contents of which are incorporated herein by reference.

### FIELD The present disclosure relates generally to a parking assistance device.

### BACKGROUND

A patent literature JP 2022-155282 A discloses a parking assistance device that, when learning travel is repeated at a close position in automatic parking (hereinafter, also referred to as learning-type automatic parking) accompanied by learning travel, provides guidance to start learning travel from a different parking start position in a case where parking positions are different.

Conventionally, a map used for automatic parking is managed with a start position as an index. Therefore, in the automatic parking technique, when the learning travel is repeated at the same start position, it is regarded that the learning travel is performed again, and there is a problem that only the parking position at the time of the last learning travel is registered even if the parking positions in the learning travel are different.

The technique disclosed in JP 2022-155282 A relates to a countermeasure against the above problem.

According to the technique disclosed in JP 2022-155282 A, in a case where parking positions are different from each other, maps having different start positions are generated by performing learning travel while changing the start position. Therefore, in the technique of JP 2022-155282 A, different parking positions can be registered in the map.

FIG. 23 is a diagram illustrating an example of automatic parking processing by the parking assistance device using the technology of JP 2022-155282 A.

In the example illustrated in FIG. 23, a parking position PA is correlated with a start position PZ by using the technique of JP 2022-155282 A. In this example, an occupant of a vehicle VA selects to park at the parking position PA by instructing the start of automatic parking at the start position PZ, the parking assistance device causes the vehicle VA to start automatic parking, and then the occupant notices that another vehicle VB is parked at the parking position PA when the vehicle VA reaches a position PY. At this time, the vehicle VA performs automatic parking in accordance with a map for parking at the parking position PA. Thus, if another vehicle VB is parked at the parking position PA, automatic parking cannot be continued.

If, for example, the parking assistance device also stores a map for parking at a parking position PB, a space at the parking position PB is vacant, so that it is only required to return to a parking start position (not illustrated) for parking at the parking position PB and restart automatic parking from the beginning. However, such a redoing of parking is too troublesome. If, for example, the map can be changed to another map in the middle of automatic parking, the automatic parking can be continued without troublesome. However, such a change of map is not possible with the conventional parking assistance device. As described above, there is room for improvement in the technology of the learning-type automatic parking in terms of convenience.

### SUMMARY

According to one aspect of the present disclosure, a parking assistance device includes processing circuitry connected to a memory. The processing circuitry is configured to register, during learning travel, a map including multiple routes from one parking start position to multiple parking positions. The processing circuitry is configured to cause, during automatic parking, a vehicle to perform autonomous travel based on the map. The processing circuitry is configured to select, during automatic parking, a route on which the vehicle is to travel from among the multiple routes.

### BRIEF DESCRIPTION OF THE DRAWINGS

FIG. 1 is a diagram illustrating an example of learning-type automatic parking performed by a parking assistance device according to an embodiment;

FIG. 2 is a diagram illustrating a vehicle to which a parking assistance ECU according to the embodiment is applicable;

FIG. 3 is a block diagram illustrating an example of a hardware configuration of the parking assistance ECU according to the embodiment;

FIG. 4 is a block diagram illustrating an example of a configuration of a parking assistance system according to the embodiment;

FIG. 5 is a diagram for explaining an example of processing of determining a position of a feature point according to the embodiment;

FIG. 6 is a diagram for explaining an example of a process of recognizing a space by a distribution of parallax according to the embodiment;

FIG. 7 is an example of a graph illustrating a distribution of parallax according to the embodiment;

FIG. 8 is a diagram for explaining an example of a process of determining whether parking is possible according to the embodiment;

FIG. 9 is a diagram for explaining an example of a process of determining a deviation in a case where the vehicle according to the embodiment deviates from a parking route;

FIG. 10 is a diagram for explaining an example of space recognition in proposal processing according to the embodiment;

FIG. 11 is a diagram illustrating an example of an image that proposes an additional parking position in the proposal processing according to the embodiment;

FIG. 12 is a diagram for explaining an example of second analysis processing according to the embodiment;

FIG. 13 is a diagram for explaining an example of the second analysis processing according to the embodiment;

FIG. 14 is a diagram illustrating an example of a structure of route data according to the embodiment;

FIG. 15 is a diagram illustrating another example of a structure of route data according to the embodiment;

FIG. 16 is a diagram illustrating an example of registration processing of a feature point according to the embodiment;

FIG. 17 is a diagram illustrating an example of registration processing of a feature point according to the embodiment;

FIG. 18 is a diagram illustrating an example of registration processing of a feature point according to the embodiment;

FIG. 19 is a diagram for explaining an example of continuous learning travel according to the embodiment;

FIG. 20 is a diagram for explaining an example of continuous learning travel according to the embodiment;

FIG. 21 is a flowchart illustrating an example of a process executed by the parking assistance ECU according to the embodiment;

FIG. 22 is a diagram for explaining an example of automatic parking executed by the parking assistance ECU according to the embodiment; and

FIG. 23 is a diagram for explaining an example of automatic parking processing of the parking assistance device using the technology of JP 2022-155282 A.

### DETAILED DESCRIPTION

Hereinafter, embodiments of the present disclosure will be described with reference to the drawings. Note that each of the exemplary embodiments described below illustrates a specific example of the present disclosure. Therefore, components, arrangement positions and connection modes of the components, steps, the order of the steps, and the like shown in the following embodiments are merely examples, and are not intended to limit the present disclosure. Further, among the constituent elements in the following exemplary embodiments, constituent elements not recited in the independent claims are described as optional constituent elements.

Each drawing is a schematic view, and is not necessarily strictly illustrated. In each drawing, substantially the same components are denoted by the same reference numerals, and redundant description will be omitted or simplified.

### Learning-Type Automatic Parking

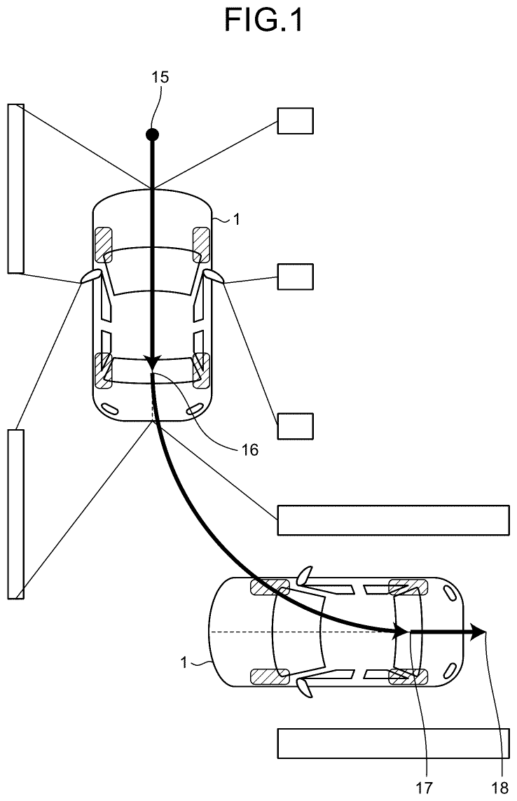

FIG. 1 is a diagram illustrating an example of learning-type automatic parking according to the present embodiment. In the learning-type automatic parking, parking is manually performed in advance, and a start position and a parking route are recorded. In the learning-type automatic parking, when an occupant (e.g., a driver) of a vehicle 1 activates an automatic parking function at the stored start position, the vehicle 1 can automatically travel and park along a parking route that was recorded when the vehicle 1 performs manual parking in advance.

More specifically, in the learning-type automatic parking, the vehicle 1 generates a map including position information of a feature while traveling in manual parking (hereinafter, also referred to as learning travel), and travels while estimating the position and posture of the vehicle 1 by using the map when automatically parking.

Here, the feature refers to an object that is present around the vehicle and does not move, such as a road surface display or an obstacle. For the position of the feature, the azimuth of an object may be determined from the positions of the images of the object appearing in a plurality of cameras, and the coordinates may be determined by the principle of triangulation. Alternatively, a distance measurement device such as a sonar or a radar may be used for determining the coordinates on the basis of distances from a plurality of positions and the principle of trilateration.

The map of the learning-type automatic parking includes position information (hereinafter, also referred to as feature information) of a feature and data of a parking route. The parking route is, for example, a route connecting a parking start position 15 and a parking position 18 as illustrated in FIG. 1. The parking route may be divided into a straight section and a curved section by being divided by an edge point 16 and an edge point 17 which are points at which the steering angle changes. The parking route data may be registered as an aggregate of data of a plurality of sections. The data of each section may be accompanied by length information, and the data of the curved section may be accompanied by information of a steering angle or a turning radius. The data of the parking route according to the present embodiment includes data of a plurality of sections.

The feature information may be, for example, data of a plurality of feature points extracted from a camera image. The feature point is a point at which a position extracted from an image of a feature appearing in a camera image can be determined, and data of the feature point registered in the map includes position information. The position information may be position information of a feature determined by the principle of trilateration, or may be position information determined by the principle of triangulation described above. Since an existing method can be used for the extraction of the feature point, a detailed description thereof will be omitted.

The parking assistance device generates a map including feature information (data of a plurality of feature points) and a parking route (data of a plurality of sections) during learning travel. During automatic parking, the parking assistance device collates data of a plurality of feature points read from the map with data of a plurality of feature points extracted from the camera image to estimate the position and posture of the host vehicle. Then, the parking assistance device controls the vehicle such that the position of the host vehicle sequentially follows a plurality of sections included in the parking route read from the map.

### Configuration of Vehicle

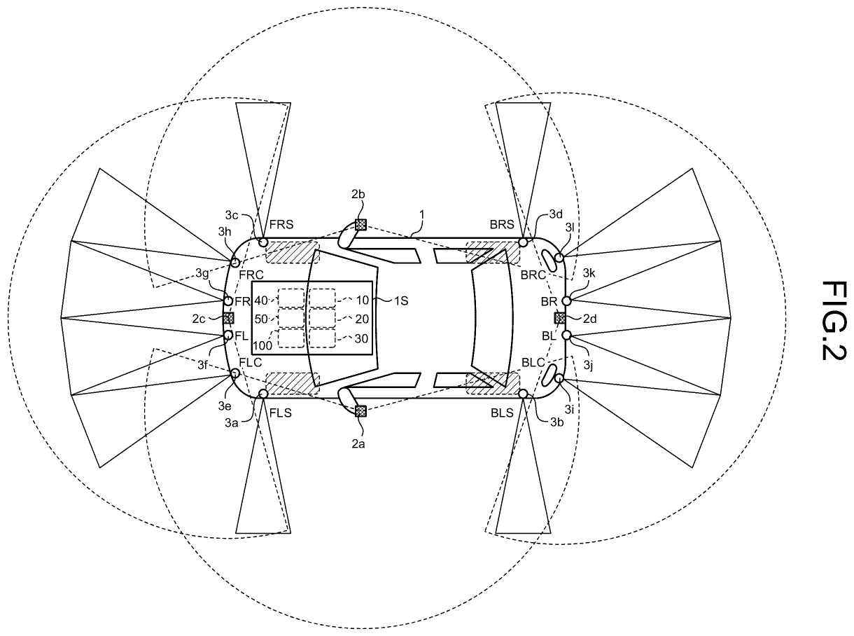

FIG. 2 is a diagram illustrating the vehicle 1 to which the parking assistance device according to the embodiment is applicable. As illustrated in FIG. 2, the vehicle 1 is equipped with a parking assistance system 1S. The parking assistance system 1S includes an operation device 10, a human machine interface (HMI) device 20, a vehicle control device 30, a navigation device 40, a sonar ECU 50, and a parking assistance ECU 100.

Note that another device may be further mounted on the vehicle 1. Although the operation device 10, the HMI device 20, the vehicle control device 30, the navigation device 40, the sonar ECU 50, and the parking assistance ECU 100 are illustrated as separate devices in FIG. 2, some or all of these devices may be integrated.

The operation device 10, the HMI device 20, the vehicle control device 30, the navigation device 40, the sonar ECU 50, and the parking assistance ECU 100 will be described later.

Cameras 2a, 2b, 2c, and 2d are provided at four positions on the front, rear, left, and right of the vehicle body of the vehicle 1. Hereinafter, in a case where the cameras 2a, 2b, 2c, and 2d are not particularly distinguished, the cameras 2a, 2b, 2c, and 2d are also simply referred to as the camera 2. Each camera 2 includes a fisheye lens, and has a visual field range of 180 degrees or more in the horizontal direction (See broken lines).

Each camera 2 is attached with a depression angle in order to capture the road surface. Therefore, when a range in which the road surface appears is converted into a visual field in the horizontal direction, a road surface in a range of about 240 degrees appears in one camera 2. For example, the front wheel, the rear wheel, and the side surface of the vehicle body of the vehicle 1 are reflected in the captured images of the side cameras 2a and 2b provided on the left and right of the vehicle body of the vehicle 1.

Note that the installation location and the number of cameras 2 are not limited to the example illustrated in FIG. 2.

As illustrated in FIG. 2, twelve sonar sensors 3a to 3l are installed in the vehicle 1. Hereinafter, the sonar sensors 3a to 31 are also simply referred to as a sonar sensor 3 unless otherwise distinguished. For example, on the left side of the vehicle 1, a sonar sensor 3a is installed on the front left side (FLS) of the vehicle 1, and a sonar sensor 3b is installed on the back left side (BLS) of the vehicle 1.

On the right side of the vehicle 1, a sonar sensor 3c is installed on the front right side (FRS) of the vehicle 1, and a sonar sensor 3d is installed on the back right side (BRS) of the vehicle 1. These four sonar sensors are also called side sonars because they detect obstacles on the side of the vehicle.

In front of the vehicle 1, a sonar sensor 3e (FLC: Front Left Corner), a sonar sensor 3f (FL: Front Left), a sonar sensor 3g (FR: Front Right), and a sonar sensor 3h (FRC: Front Right Corner) are installed in this order from the left side in the forward direction of the vehicle 1.

The sonar sensor 3f and the sonar sensor 3g provided inside detect an obstacle in the traveling direction when the vehicle 1 travels straight. In addition, the sonar sensor 3e and the sonar sensor 3h provided outside detect an obstacle in a turning direction when the vehicle 1 turns. The sonar sensors 3e and 3h are also called corner sonars. Although the detection ranges of the four sonar sensors 3e, 3f, 3g, and 3h are indicated by triangles in FIG. 1, the detection range is not limited to the triangular range, and about 10 m from the vehicle can be detected. Detection ranges of the adjacent sonars are installed so as to overlap each other.

In addition, behind the vehicle 1, a sonar sensor 3i (BLC: Back Left Corner), a sonar sensor 3j (BL: Back Left), a sonar sensor 3k (BR: Back Right), and a sonar sensor 31 (BRC: Back Right Corner) are installed in this order from the left side in the forward direction of the vehicle 1.

The sonar sensor 3j and the sonar sensor 3k provided inside detect an obstacle in the traveling direction when the vehicle 1 moves backward. In addition, the sonar sensor 3i and the sonar sensor 3l provided outside detect an obstacle in a turning direction when the vehicle 1 moves backward and turns. The sonar sensors 3i and 3l are also called corner sonars. In FIG. 2, the directions detected by the four sonar sensors 3i, 3j, 3k, and 3l and the fan-shaped spread thereof are illustrated by triangles, but the detection range is not limited to the inside of the triangle in the drawing and is spread. For example, the adjacent sonars are installed such that detection ranges thereof overlap each other. The same applies to the four sonar sensors 3e, 3f, 3g, and 3h on the front side of the vehicle.

The detection ranges of the sonar sensors 3a, 3b, 3c, and 3d installed on the sides of the vehicle 1 are set to be narrower than the detection ranges of the sonar sensors installed in the front and rear of the vehicle 1. This is to improve the resolution of the position when the parking assistance ECU 100 detects a parking space on the side of the vehicle 1 by reducing the overlapping of the detection ranges of the side sonars when the vehicle 1 moves as much as possible.

In addition, each sonar sensor is installed at a height and a depression angle at which it is easy to detect surrounding obstacles when the vehicle 1 is parked. Note that the installation location and the number of the sonar sensors 3a to 3l are not limited to the example illustrated in FIG. 2.

Here, in the present embodiment, the sonar refers to a sonar system including the above-described sonar sensors 3a to 3l and the sonar ECU 50. The sonar ECU 50 is a control device that integrally controls the sonar system.

The sonar sensor 3 emits a directional sound wave and receives a reflected wave. The sonar ECU 50 detects the distance to an obstacle based on the time from when the sonar sensor 3 emits the sound wave to when the sonar sensor 3 receives the reflected wave. The sonar ECU 50 detects the periphery of the vehicle with a large number of sonars, and determines the position of the obstacle based on the distances detected by the plurality of sonar sensors 3.

In the sonar system, an obstacle in the traveling direction of the vehicle 1 is detected by the sonar sensor 3 provided in the bumper of the vehicle 1. When detecting the obstacle, the sonar ECU 50 determines whether the vehicle 1 collides with the obstacle. When determining that the vehicle 1 and the obstacle collide within a predetermined time, the sonar ECU 50 instructs the vehicle control device 30 to operate the automatic brake.

As a result, it is ensured that the vehicle 1 does not collide with front and rear obstacles even during automatic parking. In addition, by detecting with the side sonars provided on the left and right side surfaces of the vehicle body of the vehicle 1, it is also possible to detect that the side surface of the vehicle body approaches the obstacle due to the inner wheel difference.

The sonar is not an essential component of the parking assistance system 1S. Thus, the vehicle 1 may be configured not to include the sonar. In such a case, for example, the parking assistance ECU 100 may detect the distance to the obstacle by processing the camera image captured by the camera 2. For example, the parking assistance ECU 100 may determine whether the vehicle 1 collides with an obstacle within a predetermined time. When it is determined that the vehicle collides, the parking assistance ECU 100 may instruct the vehicle control device 30 to operate the automatic brake.

### Hardware Configuration of Parking Assistance ECU

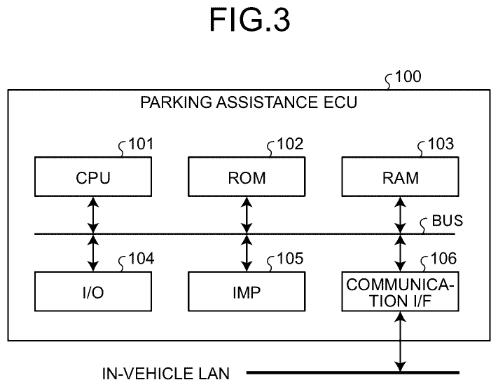

Next, a hardware configuration of the parking assistance ECU 100 will be described. The parking assistance ECU 100 is an example of a parking assistance device. FIG. 3 is a diagram illustrating an example of a hardware configuration of the parking assistance ECU 100 according to the embodiment. The function of the parking assistance ECU 100 to be described later may be implemented in hardware illustrated in FIG. 3.

The parking assistance ECU 100 may be a computer including a CPU 101, a ROM 102, a RAM 103, an input/output interface (I/O) 104, an image processor (IMP) 105, and a communication interface (I/F) 106, and connecting the respective elements via a bus.

The parking assistance ECU 100 may house a plurality of elements in one chip. In addition, the parking assistance ECU 100 may include a plurality of chips as one element. The bus is not a single bus, and a plurality of types of buses may be combined.

For example, the CPU 101, the ROM 102, the RAM 103, the IMP 105, and the communication I/F 106 may be housed in one chip and connected by a parallel bus, and the I/O 104 may be configured by a plurality of chips and connected to a chip housing the CPU 101 and a serial bus.

The parking assistance ECU 100 executes automatic parking by obtaining information from another device (for example, the navigation device 40) or giving an instruction to another device (for example, the vehicle control device 30) via the communication I/F and the in-vehicle LAN.

The CPU 101 (an example of the processing circuitry) controls the entire parking assistance ECU 100. The function of each unit of the parking assistance ECU 100 may be implemented in the form of a program executed by the CPU 101. The ROM 102 and the RAM 103 correspond to a storage unit, and the ROM 102 corresponds to a nonvolatile area. The RAM 103 is used as a work area of the CPU 101 for temporary storage. For example, a camera image such as a display image or a detection image, information of a detected feature point, and the like are temporarily stored in the RAM 103.

The IMP 105 is a processor specialized in image processing and parallel processing to improve processing performance. Processing of part of the functions (for example, an image processor 130, a space recognition unit 140, a position estimation unit 150, and the like) of the parking assistance ECU 100 to be described later may be executed by the IMP 105.

### Function of Parking Assistance ECU

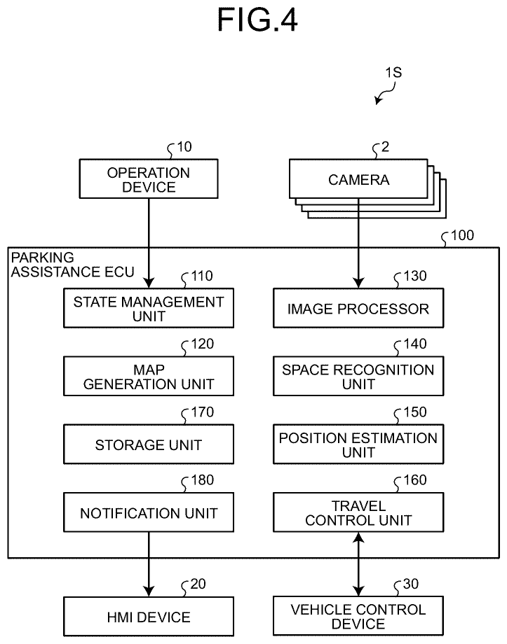

Next, functions of the parking assistance ECU 100 will be described. FIG. 4 is a block diagram illustrating an example of a configuration of the parking assistance system 1S according to the embodiment. As illustrated in FIG. 4, the camera 2 (2c (F), 2d (B), 2a (L), 2b (R)) outputs a captured camera image. The image processor 130 of the parking assistance ECU 100 receives the camera image and generates a display image or the like. The display image is output from a notification unit 180 to the HMI device 20.

The notification unit 180 superimposes a message on the display image or outputs a voice message in accordance with an instruction from a state management unit 110. The notification unit 180 is an example of a notification unit, and the HMI device 20 that is an output destination of the message and the state management unit 110 that instructs the output of the message may also be included in the notification unit. The notification unit is a functional element that transmits information to the occupant. Since the notification involves the state management unit 110, the notification unit 180, and the HMI device 20, they may be referred to as the HMI device 20 or the like.

The state management unit 110 receives a user's operation by the operation device 10 and controls a function of the parking assistance ECU 100 in accordance with the user's operation. Here, the touch panel of the navigation device 40 is included in the operation device 10.

The state management unit 110 receives position information from a main body (not illustrated) of the navigation device 40. When the learning travel is performed, the state management unit 110 adds position information of the parking start position to the map and records the position information in a storage unit 170. When automatic parking is performed, the state management unit 110 compares the position information of the navigation device 40 with the position information added to the map, and selects an available map.

The image processor 130 generates a display image and a detection image. The detection image is, for example, an image in which a change in luminance or color, namely, a contrast is emphasized. The image processor 130 extracts feature points from the detection image. The image processor 130 extracts a point corresponding to a corner or an end of a line of the image, which can be determined as a point, as a feature point, instead of a surface or a side of the image. The information on the feature point output from the image processor 130 includes information on the color and shape of the image and position information on the feature point on the camera image.

The space recognition unit 140 determines the position and distribution of the feature point. Further, the space recognition unit 140 determines a feature point not on the road surface, namely, an obstacle, by analyzing the position and distribution of the feature point. Then, the space recognition unit 140 recognizes a region where there is no obstacle, namely, a space, on the basis of the position and distribution of the determined obstacle.

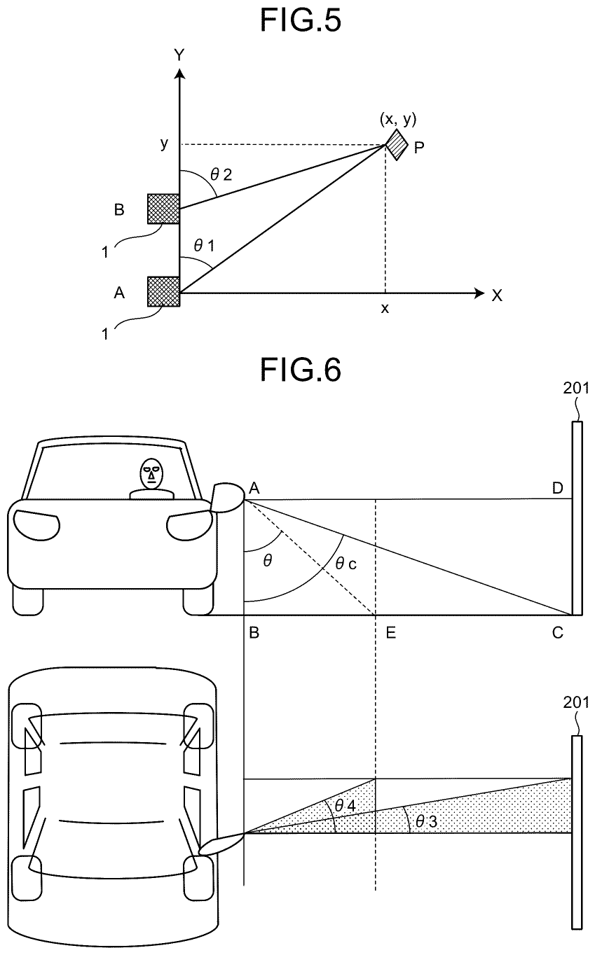

FIG. 5 is a diagram for explaining an example of a process in which the space recognition unit 140 determines the position of the feature point. As illustrated in FIG. 5, the space recognition unit 140 determines the position of the feature point (subject) P reflected in the camera 2 of the vehicle 1 by the motion parallax. First, the space recognition unit 140 converts the position of the feature point P on the camera image into an angle (azimuth angle) of the feature point P with respect to the vehicle 1. For example, it is assumed that the camera 2 of the vehicle 1 moves from the point A to the point B on the Y axis along with the movement of the vehicle 1. Then, the image of the feature point moves on the camera image, and the azimuth angle obtained from the position of the feature point P reflected in the camera 2 changes from θ1 to θ2. Such a change in the azimuth angle (θ1 to θ2) is referred to as motion parallax.

Since the distance between the point A and the point B (the length of the line segment AB) is the movement amount of the vehicle 1, it can be determined from the rotation speed of the wheel. According to the principle of triangulation, the space recognition unit 140 can determine the XY coordinates (x, y) of the feature point P from the coordinates of the line segment AB, the length, and θ1 and θ2. The position in the vertical direction in the image of the feature point P reflected in the camera 2 corresponds to the height of the feature point P. For example, if the feature point P is a tip of a bar standing perpendicular to the ground, the feature point P appears above the base of the bar in the screen. Therefore, if the space recognition unit 140 determines the XY coordinates, the Z coordinate can be determined on the basis of the position in the vertical direction in the image. In other words, the space recognition unit 140 can determine the three-dimensional coordinates of the feature point (subject) P by applying the motion parallax appearing in the camera images captured at different time points to the principle of triangulation.

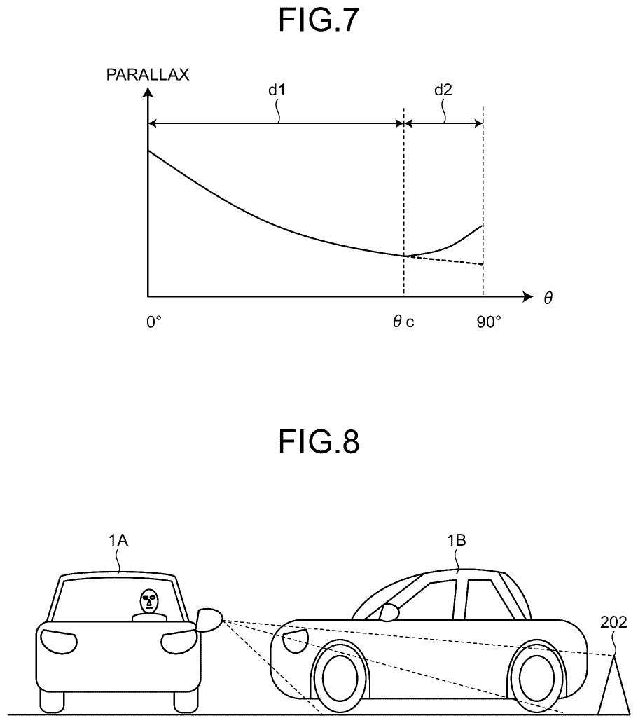

Further, the space recognition unit 140 recognizes a space based on the distribution of parallax. FIG. 6 is a diagram for explaining an example of a process of recognizing a space by distribution of parallax. FIG. 7 is an example of a graph illustrating a distribution of parallax. For example, as illustrated in FIG. 6, a case is considered in which a wall 201 perpendicular to the course of the vehicle 1 rises. A case where a road surface continues from the bottom of the vehicle 1 to a point C is assumed where a position of the camera 2 is a point A, an intersection (directly below the camera 2) between a perpendicular drawn from the point A to the road surface and the road surface is a point B, an intersection between a perpendicular drawn from the point B to the wall 201 and the wall 201 is a point C, and an intersection between a perpendicular drawn from the point A to the wall 201 and the wall 201 is a point D. A point E in the drawing is a midway point on the perpendicular line BC. In addition, each of the points B, C, D, and E, the line segment BC, and the line segment CD has a feature point.

In this case, in FIG. 7, the angle 0 indicating the direction of the feature point with 0 degrees immediately below the camera 2 is taken as the horizontal axis, and the parallax generated at the feature point is taken as the vertical axis. As illustrated in FIG. 7, the graph illustrating the parallax of the feature point reflected in the angle θ direction changes from decrease to increase with the angle θc of the point C as a boundary. Hereinafter, the reason will be described.

The lower diagram of FIG. 6 illustrates the parallax caused by the movement of the vehicle at the feature points C and E immediately beside the camera 2. The motion parallax of the feature point C is θ3, and the motion parallax of the feature point E in the middle is θ4. In this example, the motion parallax 04 of the near point B is larger than the motion parallax θ3 of the far point C. From this, it can be seen that the parallax increases as the position is closer to the camera 2. Therefore, between the point B and the point C on the road surface (range of d1 in FIG. 7 on line segment BC), the larger θ is, the smaller the parallax. On the other hand, between the point C and the point D on the wall surface of the wall 201 (range of d2 in FIG. 7 on line segment CD), the distance decreases as the height difference from the camera 2 decreases, and thus the parallax decreases as the distance decreases. Therefore, in the example of FIG. 6, the larger θ is, the larger the parallax between the point C and the point D on the wall surface of the wall 201 is. Without the wall 201, the parallax continued to decrease as indicated by the dotted line in FIG. 7, so that it can be determined that the three-dimensional object continues above the point C based on the rise of the parallax at θc.

As described above, the space recognition unit 140 can determine the position of the three-dimensional object such as the wall 201 by analyzing the distribution of the parallax. In addition, since there is no discontinuity in the distribution of the parallax up to the point C (range of d1), it is indicated that the road surface without a step is visible. Further, since there is no discontinuity in the distribution of the parallax between the point C and the point D (range of d2), it is possible to determine the presence of the wall 201. It is also possible to determine that the wall 201 is vertical from the distribution curve. In this manner, the space recognition unit 140 can determine that there is a space on the side of the vehicle 1 from the distribution of the parallax.

Further, the space recognition unit 140 detects a parking space when approaching the parking position, and determines whether parking is possible. FIG. 8 is a diagram for explaining an example of a process of determining whether parking is possible. Here, a case where the space recognition unit 140 of a vehicle 1A detects a parking space and determines whether parking is possible in the situation illustrated in FIG. 8 is considered.

In the example of FIG. 8, a triangular cone 202 is placed at the back of the parking space. In FIG. 8, it is assumed that a vehicle 1B is stopped in the parking space, but the vehicle 1B is not present during the learning travel. That is, it is assumed that the feature point of the triangular cone 202 at the back and the feature point in the parking space are registered in the map during the learning travel. In this case, the space recognition unit 140 can compare the observed motion parallax with the motion parallax during the learning travel. For example, the motion parallax observed when the direction of the floor surface of the parking space is reflected from the vehicle 1A is larger than the case where the floor surface of the parking space is reflected in the camera image without the vehicle 1B because the distance to the subject is shortened due to the presence of the vehicle 1B.

For example, the space recognition unit 140 may analyze the distribution of the motion parallax of the floor surface portion of the parking space, and may determine that parking is impossible since there is a three-dimensional object in the parking space in a case where it is determined that there is a region having a larger parallax than that at the time of learning travel as described above.

In a case where a feature point at the back of the parking space or on the floor surface of the parking space registered at the time of learning travel is not detected at the time of automatic parking, the space recognition unit 140 may determine that parking is impossible because there is an object to be shielded. In the example of FIG. 8, the space recognition unit 140 may determine that parking is impossible in a case where a feature point representing the triangular cone 202 registered at the time of learning travel is not detected.

In the present embodiment, an example in which the space recognition unit 140 performs space recognition by detection using the camera 2 will be mainly described. However, the space recognition unit 140 may determine whether parking is possible by an obstacle detection unit such as sonar or radar. For example, if the distance to the nearest obstacle on the side of the vehicle 1 is equal to or longer than the vehicle width of the vehicle 1 when the vehicle 1 is parked, the space recognition unit 140 may estimate that there is a space available for parking on the side.

Further, the space recognition unit 140 may perform processing by a combination of detection using the camera 2 and obstacle detection using sonar or the like. The space recognition unit 140 processes the feature point by the detection using the camera 2, and makes a comprehensive determination by also using the detection information of the obstacle obtained by the sonar. For example, even if the feature point of the triangular cone 202 at the back of the parking space during the learning travel does not appear in the camera image during the automatic parking, if the sonar does not detect an obstacle in a range corresponding to the floor surface of the parking space, it may be determined that parking is possible.

The position estimation unit 150 functions during automatic parking, and estimates the position of the host vehicle and the posture of the host vehicle based on the feature points registered in the map and the feature points on the camera image. In addition, the map may include a camera image captured at the start of the learning travel.

Specifically, at the time of starting automatic parking, the position estimation unit 150 collates information of the feature points detected by the image processor 130 (information of color and shape of image and information of position of feature point on camera image) with information of feature points registered in the map, and determines a feature point corresponding to the map.

When the position of the vehicle 1 at the start of automatic parking is close to the position at the start of learning travel and there is no large difference in the orientation (posture) of the vehicle body of the vehicle 1, it can be expected that the position of the feature point on the camera image at the start of automatic parking is not much different from the position of the feature point on the camera image at the start of learning travel. Therefore, the position estimation unit 150 may compare the positions of the feature points on the camera image at the start of automatic parking and the start of learning travel to extract the feature points corresponding to the map. Alternatively, the corresponding feature point may be determined by comprehensive matching processing in which the comparison of the information of the color and shape of the image is added to the comparison of the arrangement of the detected feature points and the arrangement of the feature points registered in the map. Here, the matching processing is processing of determining a feature point on the camera image that coincides with a feature point on the map.

After determining the corresponding feature point, the position estimation unit 150 compares the azimuth of the feature point registered in the map based on the start position of the learning travel with the azimuth of the feature point on the camera image, thereby determining the position and posture (orientation) of the vehicle at the start of automatic parking. For example, since the position in the left-right direction of the feature point on the camera image corresponds to the azimuth of the feature point with respect to the vehicle, the position estimation unit 150 can determine the posture of the vehicle on the basis of the position in the left-right direction of the feature point.

In addition, since the map includes three-dimensional coordinates of the feature points and the position in the up-down direction of the feature point on the camera image corresponds to the depression angle, the position estimation unit 150 can determine the distance to the feature point registered in the map on the basis of the position in the up-down direction of the feature point. The position estimation unit 150 repeats these processes for the corresponding feature points and determines the most likely value (maximum likelihood value) as the position and posture of the host vehicle.

As described above, the position estimation unit 150 determines a feature point on the map that coincides with the feature point on the image, and estimates the position and posture of the vehicle 1 from the three-dimensional coordinates of the feature point on the map and the position of the feature point on the camera image that coincides with the three-dimensional coordinates. These processes are called self-position estimation. The self-position estimation processing and the matching processing may be performed using an existing method, and detailed description thereof is omitted.

During the learning travel, a travel control unit 160 periodically communicates with the vehicle control device 30 to acquire information on the rotation speed and the steering angle of the wheels of the vehicle 1. Then, based on the acquired information, a movement amount and a posture change amount of the vehicle 1 per unit time (a change amount of the orientation of a vehicle body of the vehicle 1) are calculated.

The travel control unit 160 acquires the posture of the vehicle body of the vehicle 1 by integrating the posture change amount. The travel control unit 160 acquires a movement vector of the vehicle 1 per unit time from the acquired posture and movement amount of the vehicle body of the vehicle 1. The travel control unit 160 acquires the coordinates of the vehicle body at each time by integrating the acquired movement vectors. The travel control unit 160 connects the coordinates of the vehicle body at each time to acquire a traveling track graphically represented by a polygonal line.

The above processing is referred to as host vehicle position estimation of the travel control unit 160. In addition, a route connecting the host vehicle positions by the host vehicle position estimation is referred to as a parking route by the host vehicle position estimation.

At the time of learning travel, the travel control unit 160 may send the rotation speed and the steering angle of the wheels of the vehicle 1, or the movement amount and the moving direction (movement vector) of the vehicle 1 to a map generation unit 120 every moment as parking route information, or may send the estimated host vehicle position to the map generation unit 120 every moment. It is assumed that the travel control unit 160 of the present embodiment sends the parking route based on the host vehicle position estimation to the map generation unit 120 at the end of the learning travel. Since the parking route is a series of movement vectors per unit time, the parking route is graphically formed in the form of a polygonal line in a bird's-eye view.

At the time of automatic parking, the travel control unit 160 outputs an instruction value to the vehicle control device 30 so as to reproduce the steering angle and the travel distance recorded in the map at the same time as the host vehicle position estimation by the above method. The vehicle control device 30 controls the steering angle and the vehicle speed in accordance with the instruction value. However, the steering angle and the vehicle speed may follow the change of the instruction value with a delay, and may temporarily deviate from the instruction value. In addition, the actual steering angle and vehicle speed follow the instruction value with an offset, and may deviate from the instruction value regularly. As a result, the route estimated by the travel control unit 160 as the host vehicle position may deviate from the parking route recorded in the map.

In such a case, the travel control unit 160 performs feedback control in a direction in which the vehicle 1 is pulled back to the parking route. Specifically, the travel control unit 160 first controls the steering angle such that the course of the vehicle 1 intersects the parking route, and controls the steering angle when the vehicle 1 overlaps the parking route such that the course of the vehicle 1 follows the parking route. Specifically, the travel control unit 160 estimates the position and posture of the vehicle 1, and feedback-controls the steering angle so that the course of the vehicle 1 follows the parking route recorded in the map.

The travel control unit 160 may reproduce the vehicle speed at the time of learning travel at the time of automatic parking. In addition, the travel control unit 160 may limit the vehicle speed to a predetermined value or less at the time of automatic parking. This is because, when the vehicle speed is high, the wheels of the vehicle 1 may slip and deviate from the route. For example, the travel control unit 160 may maintain the vehicle speed during automatic parking at 5 km/h.

Since the position estimation unit 150 described above performs the self-position estimation during automatic parking, the self-position estimation of the position estimation unit 150 may be operated so as to be complementary to the host vehicle position estimation of the travel control unit 160.

For example, there is a case where the vehicle deviates from the route due to slip or centrifugal force in the turning section, but it is difficult to detect a deviation that does not appear in the steering angle or the rotation speed of the wheel in the host vehicle position estimation of the travel control unit 160.

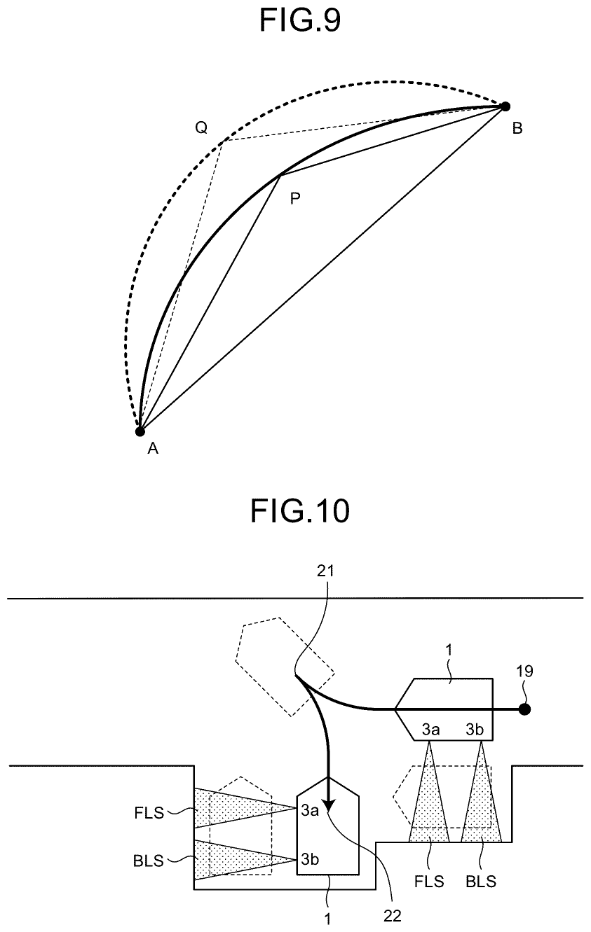

FIG. 9 is a diagram for explaining an example of a process of determining a deviation when the vehicle 1 deviates from the parking route. As illustrated in FIG. 9, for example, when the vehicle 1 is traveling on an arc AB and there is a feature point at the point A and the point B, the difference between the azimuth of the point A and the azimuth of the point B, namely, the size of a corner APB is constant when the vehicle 1 is at the point P on an arc APB in accordance with the theorem of the circumferential angle.

However, in a case where the vehicle 1 is at the point Q on an arc AQB deviated outward from the arc APB, the difference between the azimuth of the point A and the azimuth of the point B, namely, the size of the corner AQB is smaller than the corner APB. The angle difference between the corner AQB and the corner APB corresponds to the magnitude of the deviation. In this manner, by capturing the feature points in front of and behind the vehicle 1 with the camera 2 and evaluating the azimuth of the feature points, it is possible to determine the direction of deviation and the magnitude of deviation when the vehicle 1 deviates from the parking route.

Therefore, for example, the travel control unit 160 may evaluate that the reliability of the host vehicle position estimation is low when it is estimated that a slip has occurred from the rotation speed of the wheel of the vehicle 1 or in a turning section having a small turning radius, and use the estimation value of the position estimation unit 150. In this case, the travel control unit 160 may acquire data (position and posture) of self-position estimation of the position estimation unit 150, overwrite the data of the host vehicle position estimation with the data of the self-position estimation, and secure reliability of subsequent vehicle control.

The travel control unit 160 may back up the host vehicle position estimation by the self-position estimation of the position estimation unit 150. Further, the travel control unit 160 may acquire data of self-position estimation of the position estimation unit 150 without using data of host vehicle position estimation during automatic parking, and perform feedback control of the vehicle 1 using only the data of self-position estimation.

Returning to FIG. 4, the description of the parking assistance ECU 100 will be continued. The map generation unit 120 stores the feature point whose coordinates are determined by the space recognition unit 140 and the coordinates thereof in the storage unit 170 as part of the map data during the learning travel. The processing of storing the map data in the storage unit 170 as part of the map data is referred to as registering the map. The map generation unit 120 is one map generation unit. Since the map is generated by the storage unit 170 storing various data, it can be said that the storage unit 170 is also included in the map generation unit in addition to the map generation unit 120.

In addition, the map generation unit 120 registers the parking route in the map. The parking route may be, for example, a parking route based on host vehicle position estimation calculated by the travel control unit 160 on the basis of observation values of the rotation speed and the steering angle of the wheels of the vehicle 1. The map generation unit 120 may directly register, in the map, the parking route generated by the travel control unit 160 and graphically formed in the form of a polygonal line in a bird's-eye view.

The map generation unit 120 of the present embodiment receives a parking route graphically formed in a polygonal line shape in a bird's-eye view from the travel control unit 160 at the end of learning travel, and reconfigures the parking route into a plurality of sections connecting a parking start position and a parking position. Each section is obtained by approximating a polygonal parking route in either a straight section in which the vehicle travels straight at a steering angle of zero or a turning section in which the vehicle turns at a constant steering angle. This may be referred to as generation of a parking route approximating the route of the learning travel. Note that the section having the parking start position or the parking position as an edge point is approximated with the constraint condition that the parking start position or the parking position is not changed.

Then, the map generation unit 120 registers the travel distance of each section and the steering angle of the turning section on the map. As described above, when the polygonal-shaped route is simplified into a small number of sections and registered in the map, the steering angle control and the vehicle speed control at the time of automatic parking are simplified, and the data amount of the map is also reduced. In addition, since the wobble of the vehicle body is reduced at the time of automatic parking, the occupant's favorable sensitivity is increased.

The map generation unit 120 of the parking assistance ECU 100 according to the present embodiment does not completely reproduce the parking route at the time of the learning travel for the route of the automatic parking, and the parking position reproduces the parking position at the time of the learning travel. This is because, in general, the occupant does not evaluate the position of the vehicle 1 on the parking route so much, but evaluates the accuracy of the parking position.

In addition, since objects around the parking route may change in position, even if the parking route at the time of learning travel is completely reproduced, it is not ensured that the objects do not hit an obstacle. Therefore, in the present embodiment, the parking assistance ECU 100 ensures that the vehicle 1 does not collide with an obstacle or the like by the automatic brake system. Reproducing of the parking route at the time of learning travel does not produce a special effect. Therefore, it can be said that the necessity is small as compared with reproducing the parking position.

In the present embodiment, the description will be given assuming that the map generation unit 120 registers the feature points around the parking route and generates the parking route, but the generation of the parking route may be performed by another functional unit. For example, the parking assistance ECU 100 may include a route generation unit as a functional unit separately from the map generation unit 120.

In this case, the map generation unit 120 may register feature points around the parking route and register the parking route generated by the route generation unit. Alternatively, the route generation unit may generate a parking route and register the generated parking route on the map. In other words, the map generation unit 120 and the route generation unit may generate a map in cooperation.

### Map Generation Process

Next, a process of generating a map will be described. As a name, manual travel in which the vehicle travels from the parking start position to the parking position by manual driving and the parking start position and the parking position are stored is referred to as complete learning travel. The complete learning travel is the same as what has been conventionally called learning travel. On the other hand, in the learning-type automatic parking method according to the present embodiment, there are multiple types of learning travel in a form not passing through the parking start position. Therefore, in order to distinguish these types, the learning travel in which the vehicle travels from the parking start position to the parking position is referred to as complete learning travel and distinguished. Hereinafter, a process of generating a map will be described by taking a case of complete learning travel as an example.

In the present embodiment, the process of generating a map by the complete learning travel can be divided into the following processes (sub-processes) P001 to P006.

P001: Start Point Processing (registration of GPS coordinates of start position)
P002: Collection Processing (collection of feature point information, route information such as steering angle and movement amount, detection image, and the like)
P003: End Point Processing (reception of completion of learning travel and notification of analysis)
P004: Analysis Processing (arrangement of parking route)
P005: Proposal Processing (detection and presentation of parking position candidate)
P006: Registration Processing (registration of parking position and route)

The above-described process of generating a map is managed by the state management unit 110 as a whole, but the occupant is also involved in the process. Each functional unit illustrated in FIG. 4 performs a corresponding process under the management of the state management unit 110. In addition, the occupant may perform the learning travel multiple times in the process of generating a map. Therefore, each functional unit may execute a corresponding process multiple times. Note that each functional unit does not necessarily execute all the processes corresponding to the learning travel. For example, in the learning travel in which the parking position is added without starting from the parking start position, the map generation unit 120 does not execute the first start point processing. Details of each process will be described below.

### P001: Starting Point Processing

The start point processing is a process performed at a start point (parking start position) of the learning travel. The map generation unit 120 acquires GPS coordinates at the start position from the navigation device 40 and registers the GPS coordinates in the map so that the map to be used can be determined from the GPS coordinates during automatic parking at the start position (start point) of the learning travel. In addition, the map generation unit 120 performs necessary initialization processing so that feature points can be extracted, coordinates can be determined, and route information can be collected.

### P002: Collection Processing

The collection processing is a process performed on a route between the start position and the parking position. The map generation unit 120 extracts feature points and determines coordinates, and collects information (including coordinates) on the feature points. In addition, the map generation unit 120 collects route information such as a steering angle, a vehicle speed, a gear position, a moving direction, and a moving distance. In addition, the map generation unit 120 stores the detection image and the detection data on the route or at the parking position.

### P003: End Point Processing

The end point processing is a process performed at the end point (parking position) of the learning travel. The state management unit 110 starts the end point processing when the gear position becomes P. The state management unit 110 notifies the occupant to stand by while analyzing the data. The map generation unit 120 starts the next analysis processing after the above notification by the state management unit 110. Note that the state management unit 110 may cause the map generation unit 120 to start the analysis processing while outputting the notification message. As a result, the state management unit 110 can shorten the waiting time of the occupant's bodily sensation.

In the processes of generating a map, the processes P001 to P003 are processes at the time of learning travel. The process from P004 is the process after the learning travel. During the learning travel, the map generation unit 120 may prioritize data collection while avoiding processing with a large load, and may perform the process with a large load after the learning travel.

For example, in the collection processing P002, the map generation unit 120 may store only the detection image used for space recognition, and may cause the space recognition unit 140 to perform the space recognition itself during the analysis processing. In the present embodiment, the map generation unit 120 only collects the information of the feature points in the collection processing, and selects the feature points and registers the information of the feature points after the learning travel. Alternatively, the map generation unit 120 may register the information of the feature points during the collection processing, delete the information of the unnecessary feature points during the analysis processing after the learning travel, and reduce the data.

### P004: Analysis Processing

The analysis processing is mainly performed by the map generation unit 120. In the end point processing, the map generation unit 120 receives a parking route graphically formed by the travel control unit 160 with a polygonal line. In the analysis processing, the map generation unit 120 approximates the received parking route with a straight section in which the vehicle travels straight at a steering angle of 0 and a turning section in which the vehicle turns at a constant steering angle.

Then, a large amount of data describing a large number of polygonal lines is replaced with a small number of pieces of data describing a small number of sections. As a result, the route information is aggregated into the travel distance of each section and the steering angle of the turning section. A start point and an end point of each section are referred to as edge points. When the coordinates of the edge point of each section are determined, the travel distance of each section is determined. Therefore, instead of omitting the travel distance of each section from the data, coordinates of an edge point of each section may be included in the data.

The above processing is route calculation processing of setting the parking route from the start position of the learning travel to the parking position so as to be substantially along the route of the learning travel. Therefore, an existing route calculation method can be applied to the above processing. For example, the map generation unit 120 may set a plurality of edge points on the route of the learning travel and calculate a parking route including a straight section and a turning section from the parking start position to the parking position via the plurality of edge points.

Note that the process of simplifying the parking route is not essential. Thus, the map generation unit 120 may register the parking route graphically formed by the travel control unit 160 with a polygonal line as it is as the parking route. In that case, the route calculation processing of setting a route substantially along the route of the learning travel is unnecessary.

The map generation unit 120 may perform the analysis processing only once in one learning travel, or may perform the analysis processing multiple times. For example, in a case where a different parking position other than the parking position of the learning travel is added in the next proposal processing, the map generation unit 120 repeats the analysis processing and calculates a parking route for parking at the additional parking position. Thus, in a case where a different parking position other than the parking position of the learning travel is set after the learning travel, the map generation unit generates another route from the parking start position of the learning travel to the different parking position, and registers the generated another route in the map. Then, since a map having a plurality of routes from one parking start position to a plurality of parking positions can be generated, the parking position can be selected in accordance with the generated map.

### P005: Proposal Processing

The proposal processing is a process in which the state management unit 110 proposes to additionally register the parking position to the occupant of the vehicle 1. For example, the map generation unit (storage unit 170) may collect detection information around the vehicle during the learning travel and set a different parking position other than the parking position of the learning travel on the basis of the detection information. Then, another route from the automatic parking route to the different parking position is generated, and the generated another route is registered in the map. Then, since a plurality of parking positions and parking routes can be registered in one learning travel, the trouble of the occupant can be reduced. In the proposal processing, the state management unit 110 may propose the additional registration when the space recognition unit 140 detects a space available for parking. In addition, the state management unit 110 may propose additional registration regardless of detection by the space recognition unit 140. Hereinafter, setting of another parking position by detection is referred to as automatic setting, and setting of another parking position not by detection is referred to as manual setting. Here, the former automatic setting will be described, and the latter manual setting will be described later.

The space recognition unit 140 may detect a space available for parking at the parking position. Further, the space recognition unit 140 may detect a space available for parking in the middle of the parking route. The detection for automatic setting may be executed during the collection processing period, during the proposal processing period, or over both periods. For example, if the detection image and the detection data are stored in the process of the collection processing described above, the space available for parking in the middle of the parking route can be detected during the proposal processing. The processing of the stored data may be included in the analysis processing.

FIG. 10 is a diagram for explaining an example of space recognition in the proposal processing. For example, the sonar system detects a distance to a side obstacle (wall surface) by the side sonars 3a and 3b when the vehicle 1 travels straight from a parking start position 19 toward a turn-back position 21. The space recognition unit 140 may analyze the result of the detection, and may estimate that there is a space available for parking on the side of the vehicle 1 when a space having no obstacle up to a distance of 1.4 times the vehicle width of the vehicle 1 is continuous with a length of 1.2 times the vehicle length of the vehicle 1.

Further, as illustrated in the vicinity of a parking position 22 in FIG. 10, the space recognition unit 140 may estimate that there is a space available for parking between the parking position and the wall surface on the left side by the same method as described above after the vehicle 1 is parked at the parking position 22. In addition, regardless of the side sonar, the space recognition unit 140 may detect the movement parallax from the image stored for detection, determine the range in which the road surface is visible by analyzing the distribution of the parallax, and estimate that there is a space available for parking.

In a case where a second parking position (a different parking position other than the current parking position) is automatically set by the detection, as described later, an additional parking position may be proposed and registered in the map with the approval of the occupant, but the additional parking position may be automatically registered without the approval. Alternatively, acquiescence may be obtained by passively notifying. For example, when it is determined that there is a parking space for two vehicles in the garage in the learning travel, the second parking position may be automatically set without notifying the occupant. Alternatively, when a message on the screen notifies that the second parking position has been registered together with a first parking position, and the occupant does not perform an operation to cancel the registration, the registration is held. In this way, even when the first parking position is blocked during automatic parking, automatic parking can be continued by changing the course to the second parking position. The fact that the second parking position has been automatically set may be notified when the vehicle cannot be parked at the first parking position, or may be notified after automatic parking.

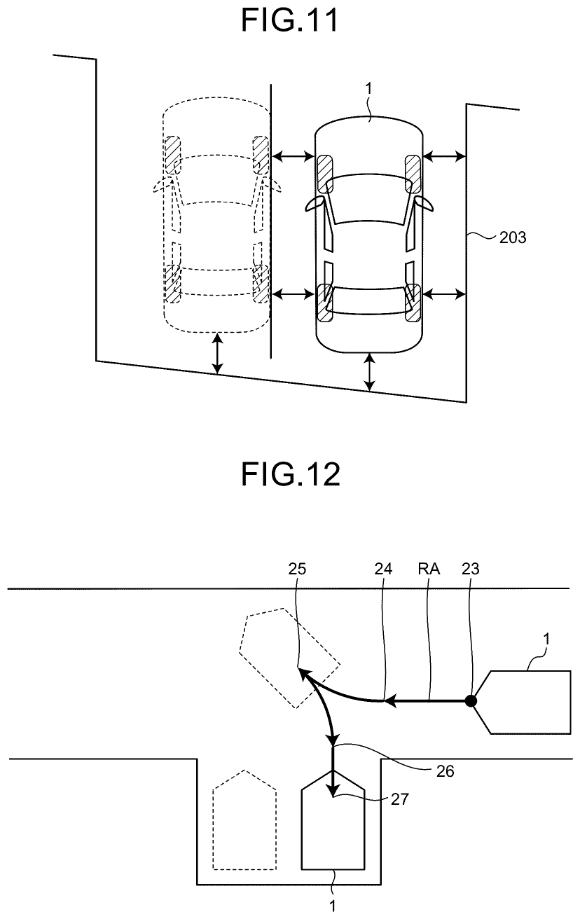

FIG. 11 is a diagram illustrating an example of an image for proposing an additional parking position in the proposal processing. For example, in a case where there is a space in which the host vehicle is accommodated on the left side of the parked vehicle 1, the state management unit 110 may display an image that proposes an additional parking position as illustrated in FIG. 11. Specifically, the state management unit 110 may control the notification unit 180 to superimpose and display a semi-transparent image indicating a virtual image parked adjacent to the bird's-eye view image output to the HMI device 20, and display a message such as “Do you want to register left space as additional parking position?” to approve or inquire of the occupant. Alternatively, the same message may be output by voice to request approval.

An image of the vehicle 1 on the right side of FIG. 11 is a model of the host vehicle. In addition, the other portion is a bird's-eye view image generated by projective transformation of the camera image. For example, the notification unit 180 superimposes and displays the model of the host vehicle on the left side of the host vehicle in the bird's-eye view image in a semi-transparent manner so that a scene in which two vehicles are parked in a garage can be imaged.

The proposed additional parking position may be set on the basis of the detection information. Specifically, the state management unit 110 may set the above additional parking position by reflecting a distance between the vehicle 1 parked in the learning travel and a peripheral object (for example, a wall). For example, as illustrated in FIG. 11, the state management unit 110 sets the additional parking position in parallel with the parked vehicle 1, and sets the distance between the additional parking position and the parked vehicle 1 to be the same as the distance between the parked vehicle 1 and a right wall 203. Further, the distance from the additional parking position to the back wall is made the same as the distance from the vehicle 1 to the back wall. In this manner, the state management unit 110 can uniquely determine the additional parking position by reflecting the distance between the vehicle 1 parked in the learning travel and the peripheral object in the additional parking position. Since the parking position of the vehicle 1 reflects the distance that the occupant feels safe and the preference of the occupant, the additional parking position is preferable for the occupant by reflecting the distance between the parking position of the vehicle 1 and the peripheral object in the additional parking position.

Further, for example, the state management unit 110 may display an image indicating the automatically set additional parking position on the touch panel of the navigation device 40 so that the occupant can move the image of the additional parking position by operating the touch panel. Then, in a case where the automatically set additional parking position is not preferable, the occupant can manually adjust the additional parking position to suit the preference.

In the above case, for example, in a case where the state management unit 110 displays an image proposing an additional parking position and then accepts the pressing of the approval button by the occupant as it is, the map generation unit 120 registers the proposed additional parking position. In addition, in a case where the pressing of the approval button is accepted after the state management unit 110 accepts the operation of moving the additional parking position by the occupant, the map generation unit 120 registers the additional parking position changed by the operation of the occupant. In the former case, the additional parking position to be registered is an automatically set position, but since the additional parking position is manually approved by the occupant, it can be said that the additional parking position is manually set.

Such a method of setting the additional parking position only by the proposal processing is referred to as manual setting of the additional parking position in order to distinguish from a method of setting the additional parking position by the additional learning travel. Further, the proposal processing may be referred to as a proposal unit. The proposal unit proposes addition of a parking position to the occupant when the vehicle is parked in the learning travel, and sets another parking position on the basis of an operation or approval of the occupant. Then, the map generation unit generates another route to another parking position, and registers the generated another route in the map. As described above, according to the manual setting, the additional parking position can be registered without actually parking, and the setting can be manually changed to suit the preference, which is convenient and suitable.

As described above, detection information around the vehicle may be collected during the learning travel, a parking position candidate may be automatically set based on the detection information, and a parking position candidate may be proposed to the occupant of the vehicle. Then, since the parking position is substantially set to a good parking position at the time when the parking position is proposed to the occupant, the occupant may finely correct and approve the parking position, or may approve the parking position as it is. In this way, by using the automatic setting in combination with the manual setting, it is possible to support the setting of the occupant and save the trouble of the manual adjustment.

The manual setting in which the automatically set additional parking position is manually adjusted and set has been described above, but the additional parking position may be manually set without being automatically set. On the premise that the proposal unit causes the occupant to set the additional parking position, the detection processing for detecting the space available for parking may be omitted. For example, the state management unit 110 may simply display “Do you want to register another parking position?” or the like on the HMI device 20 or the like to make an inquiry to the occupant. In a case where the answer to the inquiry is Yes, the state management unit 110 may set the additional parking position in accordance with the operation of the occupant received by the HMI device 20.

In a case where the detection processing is not performed, a plurality of parking position candidates based on a layout of a general parking lot may be presented, and the occupant may perform selection and operation. For example, in a case where the occupant's answer to the inquiry is Yes, the HMI device 20 may display a bird's-eye view image in which parking frames indicating additional parking position candidates are arranged on the front, rear, left, and right of the image of the vehicle 1. Then, the occupant selects a direction in which the parking position is set on the bird's-eye view image. In addition, the state management unit 110 may not display a parking frame in a direction in which a close obstacle is detected. For example, in the arrangement as illustrated in FIG. 11, parking frames are not displayed on the right side and the rear side of the vehicle 1. When the occupant touches one of the displayed parking frames, the other parking frames disappear, and the touched parking frame moves following the movement of the finger. The mechanism of causing the occupant to operate the position of the frame and confirming the position by the approval button may be the same as the above-described method.

Here, in a case where it is approved to add the parking position in the proposal processing, the execution order of the process of generating the map is as follows: P001: Starting point processing, P002: Collection processing, P003: End point processing, P004: Analysis processing, P005: Proposal processing, P004: Analysis processing, P005: Proposal processing, and P006: Registration processing. This is because the second analysis processing is executed in order to calculate the parking route to the additional parking position.

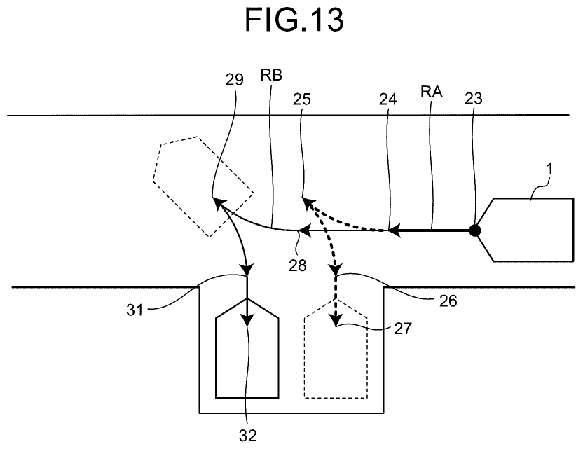

The second analysis processing will be described below. FIGS. 12 and 13 are diagrams for explaining an example of the second analysis processing. A route RA (hereinafter, also referred to as a parking route RA) in FIG. 12 is a route traveled in the learning travel. The learning travel starts at a parking start position 23 and ends at a parking position 27 (hereinafter, also referred to as a first parking position 27), and first analysis processing and proposal processing are performed after parking. For example, in the second analysis processing, the map generation unit 120 generates a route RB (hereinafter, also referred to as a parking route RB) diverging from the parking route RA of the learning travel and parking at an additional parking position 32 (hereinafter, also referred to as a second parking position 32). Assuming that the route referred to at the time of route generation is a reference route, it can be said that the map generation unit generates another route (for example, the parking route RB) based on the reference route (for example, the parking route RA). The reference route only needs to be a set route, and may be a route registered in a map. When such an existing route is used, the time required for route calculation can be shortened.

In general, the second parking position 32 is often set in parallel with the first parking position 27. For this reason, the map generation unit 120 may use the parking route RA when generating the parking route RB, and may use part of the parking route RA translated as the parking route RB.

As illustrated in FIG. 12, the parking route RA includes a straight section 23-24, a turning section 24-25, a turning section 25-26, and a straight section 26-27.

Since the data of the route is an aggregate of data of sections constituting the route, generating another route on the basis of the reference route is nothing less than generating data of a section of another route on the basis of data of a section constituting the reference route. Specifically, when generating another route based on the reference route, the map generation unit generates data of a section of another route by copying, processing, or sharing data of the reference section. By doing so, it is possible to shorten the time for generating the route and reduce the data amount of the route.

A route for parking at the second parking position 32 generated in the second analysis processing is referred to as a parking route RB. The map generation unit 120 may set, as the section of the parking route RB, the section of the parking route RA translated by the distance between the first parking position 27 and the second parking position 32. For example, as illustrated in FIG. 13, the map generation unit 120 translates the sections 24-25, 25-26, and 26-27 of the parking route RA to obtain the sections 28-29, 29-31, and 31-32 of the parking route RB. Further, the map generation unit 120 sets a straight section 24-28 between an edge point 24 and an edge point 28.

The translated section data takes over the original section data. Specifically, the map generation unit 120 sets the data in the section 28-29, the section 29-31, and the section 31-32 to be the same as the data in the section 24-25, the section 25-26, and the section 26-27, respectively. In other words, the data of the reference section is copied to be the data of the section to be generated. In addition, the map generation unit 120 sets the distance between the first parking position 27 and the second parking position 32 as the distance data of the straight section 24-28, and sets the steering angle data to 0 since it is the straight section. As a result, the map generation unit 120 starts at an edge point 23, passes through the edge points 24, 28, 29, and 31, and completes the setting of the parking route RB for parking at the second parking position 32. Since the parking route RB is divided from the parking route RA at the edge point 24, the edge point 24 is referred to as a branch point. In addition, a route that starts at the edge point 24, passes through the edge points 28, 29, and 31, and ends at the edge point 32 is referred to as a branch.

A branch route is a type of route. When a branch route is connected to a route registered in a map starting from the parking start position or a set route, another route from the parking start position to another parking position is formed. That is, another route from the parking start position to another parking position may be registered by registering the branch route in the map. For example, in the registration processing to be described later, the map generation unit 120 may register, in the map, a branch route (parking route RB) that is parked at the second parking position 32 via 28, 29, and 31 with an edge point 24 (branch point) as a start point. Then, it is possible to park the vehicle at the second parking position 32 by branching at the edge point 24 (branch point) from the parking route RA for parking at the first parking position 27 with the edge point 23 (parking start position) as a start point. Alternatively, the parking route RB may be set as a route starting from the edge point 23 (parking start position) and added to the map as a route independent of the parking route RA. In the latter case, the data of the first straight section 23-24 of the parking route RB is generated by copying the data of the first straight section 23-24 of the parking route RA.

When adding a branch route or a parking route to the map, the map generation unit 120 adds a link to the parking route. Here, the link is an address or an offset that designates a jump destination when jumping a data reading position. The link to be added to the parking route jumps to either data of another route contained in the same map as the map containing the route or data of another route contained in a different map other than the map containing the route. If a link is added to the parking route, when the state management unit 110 sequentially reads the data of the parking route from the storage unit 170 and performs automatic parking, the parking route and the parking position can be changed by jumping the read address in accordance with the link indicating the head address of the data of another route or the data of the branch route.

In the former case, a link to jump to the data of the section 24-28 of the parking route RB is added to the data of the section 23-24 of the parking route RA. In the latter case, the map generation unit 120 adds a link to the parking route RA, and adds a link that jumps to the data of the section 24-25 of the parking route RA to the data of the section 23-24 of the parking route RB generated by copying the data of the section 23-24 of the parking route RA. This is an example of processing after copying the data of the reference section. If a link to the other party's route is added to both the routes RA and RB, when the state management unit 110 reads the data of the parking route from the storage unit 170, it is possible to jump to the data of the other parking route even in a case where reading is started from the data of either parking route.

The link may be designated by an absolute address or a relative address.

For example, in a case where the data of the parking route RA is previously registered in the map data and the data of the branch route is additionally registered, the address of the data of the section 23-24 of the parking route RA is previously determined. When the data of the branch route is additionally registered later, the head address of the data of the section 24-28 of the branch route is determined at that time. Therefore, the map generation unit 120 may calculate a difference (address offset) of addresses and set the difference as a link in the data of the section 23-24 of the parking route RA.

In a case where a branch route is added to the map, the state management unit 110 always starts to read the route from the parking route RA when reading the route from the storage unit 170. Then, the state management unit 110 may select whether to jump to the data of the branch route or continue reading the data of the parking route RA when the link is read.

In addition, in a case where the parking route RB is registered separately from the parking route RA instead of registering the branch route, the map generation unit 120 may register the parking route RB in an independent map different from the map in which the parking route RA is registered. In this way, when one map corresponds to one parking route (parking position), it is easy to manage the map. Note that, since all the map data is on the ROM, a link to jump to another map can also be set, and even if the link jumps to another map, there is no delay in the processing.

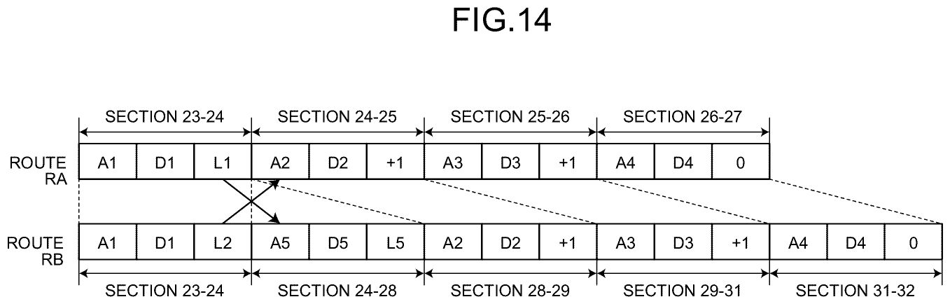

Next, a data structure of the route data will be described. FIG. 14 is a diagram illustrating an example of a structure of route data. FIG. 14 illustrates data structures of the route RA and the route RB. As illustrated, the data of the route is an aggregate of data of the section.

The section data includes three words. A word is a unit of data having one address. One word may be, for example, 16 bits or 32 bits. The route data is included in the map data. The map data is written in an electrically rewritable ROM (for example, the ROM 102 of the parking assistance ECU 100). The map data can be accessed in units of words.

A first word Ax of the section data indicates the steering angle and the traveling direction. A second word Dx of the section data indicates the travel distance of the section. A third word of the section data is a link. If the link is 0, it indicates that the section is the last section, if the link is 1 (+1), it indicates that the next section continues without branching, and if the link is other than 0 and 1, it indicates the relative address (offset) of the branch destination.

For example, a third word L1 of the section 23-24 of the route RA is an offset up to the first word of the section 24-28 of the route RB. A third word L2 of the section 23-24 of the route RB is an offset up to the first word in the section 24-25 of the route RA. Normally, since the first word of the next section is at the next address, the offset in the case of not branching is +1. Therefore, the link of 1 may be referred to as an implicit link in the case of not branching.

When a links Lx that is not 0 and 1 is read from the storage unit 170, the map generation unit 120 adds Lx to the address in the case of branching, and increments the address by +1 in the case of not branching. The implicit link (+1) in the case of not branching is omitted for the link in the section with a branch. Further, since link=0 indicates the final section, the vehicle may stop after traveling the distance designated by the second word Dx and end the automatic parking.

In the example of FIG. 14, the map generation unit 120 generates the data of the route RB using the data of the route RA. First, the map generation unit 120 copies the head section of the route RA to obtain the head section 23-24 of the route RB. Next, the map generation unit 120 inserts the straight section 24-28 after the section 23-24. A second word D5 in the straight section 24-28 is set based on the distance between the first parking position 27 and the second parking position 32 in FIG. 13. Then, when the map generation unit 120 copies the data of each of the section 24-25, the section 25-26, and the section 26-27 of the route RA and pastes the copied data as the data of each of the section 28-29, the section 29-31, and the section 31-32 of the route RB, the data of the route RB is completed.

In this way, by using the data of the route RA, the map generation unit 120 can generate the route RB with a small amount of calculation. In the example of FIG. 14, since the data of the route RA and the data of the route RB are independent, the data of the route RA may be read when the target parking position is an edge point 27, and the data of the route RB may be read when the target parking position is the edge point 32. Even if reading is started from any route, the route can be changed on the way.

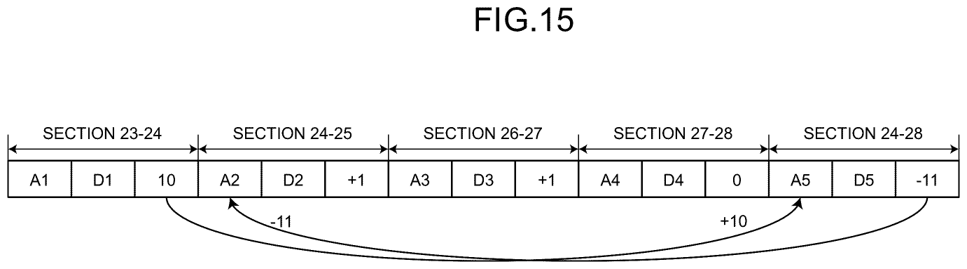

Note that the data structure of the route is not limited to the above. FIG. 15 is a diagram illustrating another example of the data structure of the route. For example, the map generation unit 120 may generate data of a section of another route (route RB) by sharing part of the data of the reference section (route RA). When the data of the section is shared, the data amount of the route can be reduced.

The example of FIG. 15 corresponds to a configuration in which a branch route is added to the data of the route RA. Therefore, the state management unit 110 starts reading from the data of the head section 23-24 of the route RA regardless of the target parking position. Then, when the vehicle 1 reaches the end of the section, the state management unit 110 determines whether to branch. In the case of branching and causing the vehicle 1 to travel the route RB, the link jumps to the data of the section 24-28 in accordance with the link (offset=10) of the section 23-24. The vehicle 1 travels straight by the distance indicated by D5 under the control of the travel control unit 160.

Then, since the vehicle 1 reaches the position of the edge point 28 in FIG. 13, the vehicle 1 may travel on a route obtained by translating the sections 24-25 to 26-27 of the route RA. Therefore, the state management unit 110 jumps the read address to the data in the section 24-25 in accordance with the link (offset=−11) in the section 24-28. As illustrated in FIG. 14, the data in the sections 28-29 to 31-32 of the route RB is the same as the data in the sections 24-25 to 26-27 of the route RA. Therefore, when the address is jumped to the data of the sections 24-25 to 26-27 of the route RA and the same data is read, the vehicle 1 travels on the combined route at the position translated by the distance indicated by D5.

As described above, in a case where the second parking position can be set parallel to the first parking position, the map generation unit 120 can reduce the amount of calculation for generating a route or reduce the amount of data to be handled by using the data of the existing section. In addition, in a case where the second parking position is not parallel to the first parking position and has an angular difference, the turning section may be inserted as the first section of the branch route, and the angular difference may be compensated in the turning section, so that the data of the section of the first route can be used.

In the above description, an example has been described in which the map generation unit 120 stores data of each section of the route in consecutive addresses. However, the map generation unit 120 may dispersedly arrange the data of each section. In this case, the data of the section requires a link to the next section in the case of not branching. Therefore, the data of the section may include a data field indicating the number of links.

The data field indicates a range assigned to one piece of data. The data field may be some bits in one word. The data field may span a plurality of words. In addition, the number of links may be increased to enable branching from one branch point in three or more directions. A plurality of branch points may be provided to configure a parking route that allows parking at three or more parking positions.

Next, the second proposal processing will be described. After completion of the second analysis processing, the state management unit 110 performs the second proposal processing together with the notification unit 180. In a case where there is a space available for parking in a place not set as the parking position in the second proposal processing, the state management unit 110 may display “Do you want to register another parking position?” or the like on the HMI device 20 or the like to inquire of the occupant.

Further, the state management unit 110 may simply display “Do you want to register another parking position?” or the like on the HMI device 20 or the like to make an inquiry to the occupant without causing the space recognition unit 140 to perform the space recognition. Note that, in a case where there is no other space in which another parking position can be set, or in a case where the parking position cannot be added due to restrictions such as the data capacity of the map, the state management unit 110 may notify the occupant by displaying “Registration of parking position is ended” on the HMI device 20 or the like without making an inquiry.

In a case where the response of the occupant to the inquiry is Yes, the same processing as the case where the response of the occupant is Yes may be repeated in the first proposal processing, and thus the description thereof will be omitted. If the occupant's answer is No, the state management unit 110 notifies the occupant by displaying “End addition of parking position” or the like on the HMI device 20 or the like, and the process proceeds to the registration processing.

### P006: Registration Processing

In the registration processing, the map generation unit 120 registers the data of the parking route and the data of the feature point in the map. Hereinafter, registering data of feature points on a map is referred to as registering feature points. Since the map generation unit 120 registers the feature points in the map in order to detect the motion of the vehicle 1 on the parking route, it is preferable to intensively register the feature points advantageous for detecting the motion. For example, a feature point that greatly moves on the camera image when the vehicle 1 moves or turns on the route has higher sensitivity than a feature point having a small movement amount, which is advantageous in detecting the motion of the vehicle 1.

Since the map generation unit collects information on feature points around the vehicle during the learning travel, at least information on feature points located near another parking position may be registered in the map when another route is registered in the map. For example, in a case where the parking position at the time of learning travel and the parking position at the time of automatic parking are different from each other, the feature point near the parking position changes its position more greatly on the camera image than the feature point far from the parking position. Therefore, it is possible to more accurately align the parking position by intensively registering the feature point near the parking position.

Registering feature points intensively in the vicinity of a specific position may be rephrased as increasing allocation points. For example, the map generation unit 120 may increase the allocation point in a region corresponding to the normal direction of the end point of the straight section or a region corresponding to the tangential direction of the end point of the turning section, and intensively register the feature points. In a case where the parking position is added, the number of regions to be allocated increases. Therefore, the map generation unit 120 may make the allocation points different between the case where the parking position is added and the case where the parking position is not added.

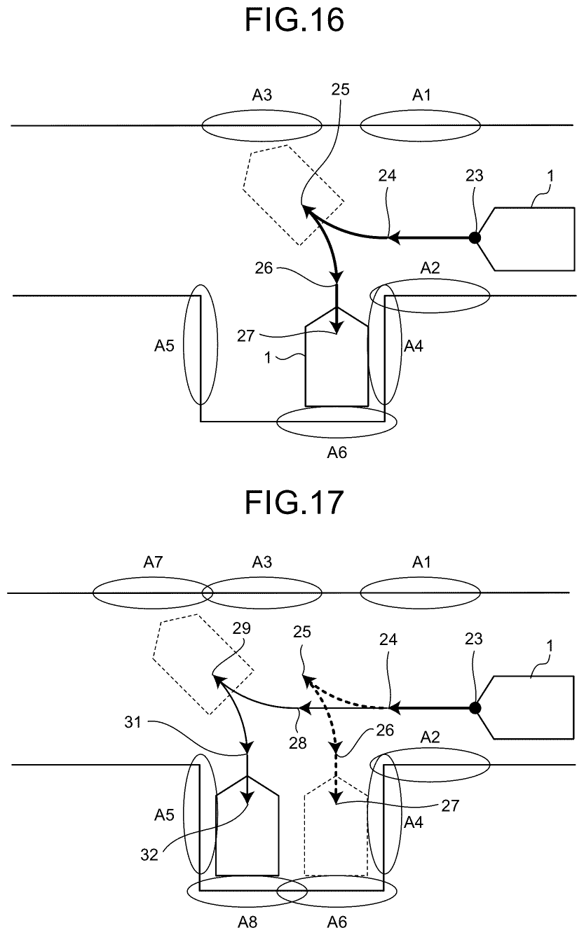

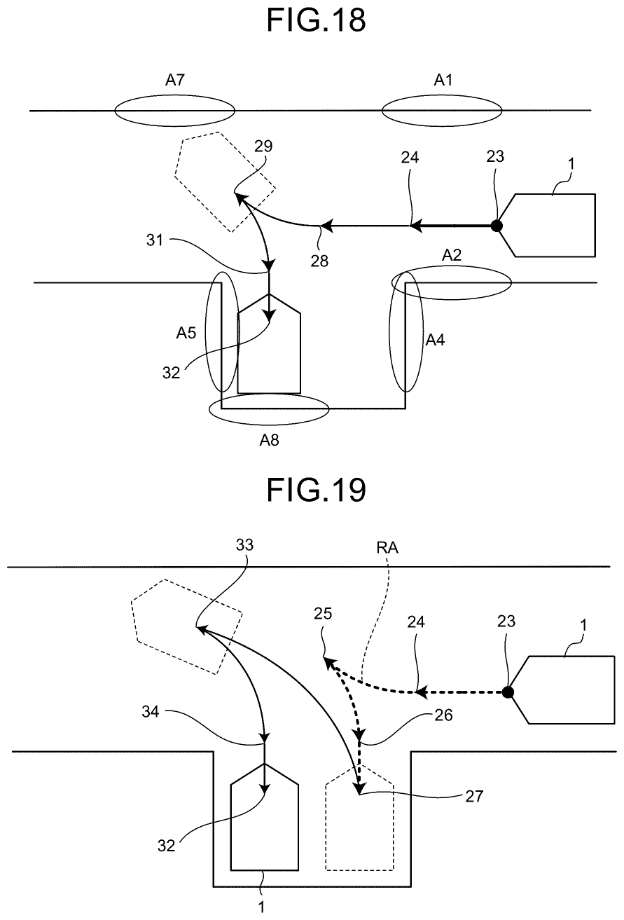

FIGS. 16 to 18 are diagrams illustrating examples of feature point registration processing. In FIG. 16, a region Ax (x=1 to 6) indicated by an oval is a region where the allocation point is increased on the map in which the route RA of FIG. 12 is registered. Ax in FIG. 18 is a map in which only the route RB in FIG. 13 is registered, and is a region in which allocation points are increased. Ax in FIG. 17 is a map in which the route RA and the route RB in FIG. 13 are registered, and is a region where the allocation points are increased.

The necessity of additional registration of feature points will be described. For example, a case will be considered in which the route RB is additionally registered in a map in which the feature points of the route RA of FIG. 12 and the region Ax of FIG. 16 are registered, and no feature point is additionally registered. In this case, for example, since there is no feature point in the traveling direction at the time of turning back at an edge point 29, the position in the left-right direction and the posture (orientation) of the vehicle body may be inaccurate. Therefore, a large number of feature points may be arranged (allocated) also in a region A7 that is a region existing in the tangential direction at the edge point 29.

The feature point at the back of the parking position 32 is also important in accurately controlling the position in the left-right direction and the posture of the vehicle body. Therefore, the map generation unit 120 may arrange many feature points also in a region A8 existing in the traveling direction of the section 31-32. As described above, when the map generation unit 120 additionally arranges the feature points corresponding to the addition of the parking route, the distribution of the region where many feature points are arranged is as Ax in FIG. 17, and the vehicle 1 can be automatically parked with high accuracy regardless of which one of the parking positions 27 and 32 is selected.

Note that, in a case where the total number of feature points to be registered in one map is determined, the density of feature points decreases when the number of parking positions increases, and thus, there is a possibility that the accuracy of parking deteriorates. Therefore, the map generation unit 120 may generate a different map for each parking position and make the feature points registered for each map different. For example, the feature point indicated by Ax in FIG. 16 is registered in the map in which the route RA is registered, and the feature point indicated by Ax in FIG. 18 is registered in another map in which the route RB is registered. In this way, a decrease in the density of the feature points is suppressed, so that parking accuracy can be maintained. In other words, during automatic parking, the position estimation unit 150 can maintain the accuracy of self-position estimation.

Even if the map is divided into two, the amount of data is not necessarily doubled. For example, a case where a map M1 including the feature point Ax and the route RA in FIG. 16 and a map M2 including the feature point Ax and the route RB in FIG. 18 are individually generated will be considered. In this case, the map generation unit 120 mutually sets a link that jumps from the edge point 24 of the map M1 to the edge point 24 of the map M2 and a link that jumps from the edge point 24 of the map M2 to the edge point 24 of the map M1. As a result, the state management unit 110 can select the parking route at the edge point 24 (branch point).

Since the data of the route RA and the data of the route RB are partially the same as illustrated in FIG. 14, the data amount may be reduced by compression as illustrated in FIG. 15. However, since the data amount of the route is originally not large, there is no large difference even if the data is compressed. On the other hand, many of the feature points registered in the map M2 overlap with the feature points registered in the map M1. Since the number of feature points is large and the data amount is large, if there are a large number of overlapping feature points, the utilization efficiency of the storage capacity is deteriorated. Therefore, the map generation unit 120 may store the feature points existing in the regions A1, A2, A4, and A5 to be redundantly registered in the two maps in the shared data to avoid duplication.

When reading the map M1, the state management unit 110 may read feature point data dedicated to the map M1 (feature points existing in the regions A3 and A6) and shared data (feature points present in regions A1, A2, A4, and A5). In addition, when reading the map M2, the state management unit 110 may read feature point data dedicated to the map M2 (feature points existing in the regions A3 and A6) and shared data (feature points present in regions A1, A2, A4, and A5).

As described above, when there are the shared data and the dedicated data, the shared data and the dedicated data may be read and merged on the RAM, or the shared data and the dedicated data may be accessed without distinction while being placed in different areas on the ROM.

In a case where the registration processing is completed, the state management unit 110 may or may not notify the occupant that the registration processing is completed. This is because it is not necessary to request approval or operation from the occupant when the registration processing is completed.

For example, in a case where an IG-OFF operation is performed during the execution of the registration processing by the map generation unit 120, the state management unit 110 may request a power supply circuit (not illustrated) to maintain the power supply to the parking assistance ECU. In this case, the state management unit 110 may turn off the power supply without notifying anything at the time point when the registration processing by the map generation unit 120 is completed. This is because the notification cannot be performed because the HMI device 20 and the like do not function due to the IG-OFF operation. In addition, if the IG-ON state is established at the time when the registration processing is completed, the state management unit 110 may notify the occupant by displaying a message such as “Registration of map is completed” or “Automatic parking is available on the learned route” on the HMI device 20 or the like. In addition, in a case where the registration processing is completed but the notification cannot be performed, the same notification may be performed when the IG-ON state is set next.

So far, in the proposal processing, an example has been described in which another possible parking position candidate is displayed on the HMI device 20 or the like, and the parking position is set by the operation and approval of the occupant. Such a method of manually setting the additional parking position is simple because the parking position can be added without actually parking. However, when the vehicle is actually parked, it can be expected that a parking position that matches the preference of the occupant and has an optimal distance from a peripheral object is set, and when the vehicle is actually parked, the occupant is also satisfied. Therefore, the state management unit 110 may set the parking position by manually parking the vehicle by the occupant.

### Continuous Learning Travel

From here, the continuous learning travel will be described. The continuous learning travel is a learning travel started after parking in the learning travel. The continuous learning travel starts from the parking position where the vehicle 1 is parked in the learning travel. The map generation unit sets, as another parking position, a parking position when the occupant of the vehicle 1 leaves the vehicle 1 by manual driving and parks the vehicle 1 at a position different from the parking position from which the vehicle has left. Then, another route from the parking start position of the learning travel to another parking position is generated, and the generated another route is registered in the map. For example, in a case where there are a plurality of available parking spaces in the garage, a plurality of parking positions are registered. However, according to the continuous learning travel, it is not necessary to return to the parking start position and start the learning travel. Therefore, a plurality of parking positions can be registered in a short time.

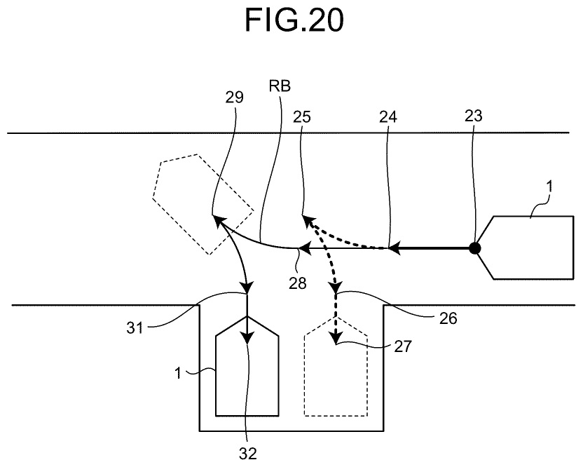

FIGS. 19 and 20 are diagrams for explaining examples of the continuous learning travel. For example, as illustrated in FIG. 19, after the vehicle 1 is parked at the first parking position 27 from the edge point 23 via 24, 25, and 26, the state management unit 110 causes the HMI device 20 or the like to display “Do you want to register another parking position?” or the like to make an inquiry to the occupant.

If the occupant's answer is Yes, the state management unit 110 causes the HMI device 20 or the like to display “Move vehicle and park at next parking position.” or the like, and requests the occupant to perform manual parking. In response to this, as illustrated in FIG. 20, the occupant parks at the parking position 27 via a turn-back point 33 and a turning end point 34 from the parking position 32. Then, the state management unit 110 determines the second parking position 32 on the basis of manual parking by the occupant.

In the above case, the process of generating the map proceeds to P001: start point processing, P002: collection processing, P003: end point processing, P004: analysis processing, and P005: proposal processing, before the start of the continuous learning travel, and the continuous learning travel is requested in the proposal processing. Then, after the continuous learning travel is started, the process of generating the map proceeds to P002: collection processing, P003: end point processing, P004: analysis processing, P005: proposal processing, and P006: registration processing. Since the content of each process is substantially the same as that in the case of manual setting without actually parking described above, differences will be mainly described.

In the continuous learning travel, first, collection processing is performed. This is because the feature point information is collected also on the route to the second parking position 32, and the feature point more advantageous for detection is registered in the map.

The second collection processing may be the same as the collection processing on the route to the first parking position 27. The map generation unit 120 handles the feature point information collected in the second collection processing and the feature point information collected in the first collection processing without distinction. The state management unit 110 performs the second end point processing when the gear position reaches P, and the notification unit 180 notifies the occupant to wait. The map generation unit 120 starts the second analysis processing simultaneously with the notification by the notification unit 180.

Before the second analysis processing, the map generation unit 120 receives a movement route (route to the second parking position 32 from first parking position 27 via edge points 33 and 34) between the first parking position 27 and the second parking position 32 from the travel control unit 160. This route is a movement route graphically represented by a polygonal line. Here, the map generation unit 120 determines a relative positional relationship between the first parking position 27 and the second parking position 32 on the basis of the movement route. However, the map generation unit 120 does not perform the process of approximating the received movement route (represented by a polygonal line) by the straight section and the turning section. This is because the route for moving from the first parking position 27 to the second parking position 32 is an unnecessary route that is not used when automatic parking is performed.

In the second analysis processing, the map generation unit 120 calculates the parking route RB as illustrated in FIG. 20 based on the relative positional relationship between the first parking position 27 and the second parking position 32 and the parking route RA for parking at the first parking position 27. A method has been described above in which a bird's-eye view is shown to the occupant in the proposal processing, the additional parking position is set on the screen, and the parking route from the parking start position to the additional parking position is calculated in the analysis processing. However, among the processing, the process of calculating the parking route from the parking start position to the additional parking position can be performed regardless of the method of setting the additional parking position. Thus, when the second parking position 32 is set by the continuous learning travel, the subsequent route calculation is the same as the case of the manual setting. Therefore, in order to avoid duplication, the description will be omitted.

Since the next proposal processing may be the same as the first proposal processing performed before the continuous learning travel is started, the description thereof is also omitted. In addition, the final registration processing is also substantially the same as the case of manual setting.

In a case where the continuous learning travel is performed, in the registration processing, the map generation unit 120 registers the feature point information collected in the first and second collection processing in the map. This point is different from the case of the manual setting in which the collection processing is performed only once. Thus, the map generation unit collects information on feature points around the vehicle when the occupant of the vehicle travels by manual driving after the learning travel, and registers at least information on feature points located near another parking position on the map when registering another route in the map.

From the principle of triangulation, when the coordinates of the feature point are determined, the accuracy of the coordinates is higher in a case where the coordinates are determined close to the feature point than in a case where the coordinates are determined away from the feature point. For example, the coordinates of the feature point near the second parking position 32 determined during the continuous learning travel for parking at the second parking position 32 have higher accuracy than the coordinates determined during the first learning travel. In addition, a feature point not detected in the first collection processing may be detected in the second collection processing, and a newly detected feature point may be advantageous for vehicle position estimation on a new parking route. Therefore, in a case where the feature points collected in the continuous learning travel are registered, it can be expected that the accuracy of the parking position at the time of automatic parking at the second parking position 32 is improved as compared with the case where the feature points collected in the first learning travel are registered.

When the parking position is added, a region where many feature points are to be arranged is increased, which is the same as the case of the manual setting. The registration processing of registering the newly collected feature point in the map may be the same as the case of the manual setting, and thus the description thereof will be omitted.

Although the example in which the continuous learning travel is started immediately after the first learning travel has been described so far, the continuous learning travel does not necessarily need to be started immediately after the first learning travel. For example, the occupant may start the continuous learning travel on another day.

Specifically, if the vehicle 1 has not moved after the first learning travel and the data collected in the first collection processing has not been erased, the occupant can start the continuous learning travel even if the IG of the vehicle is turned OFF/ON on the way. For example, when the vehicle 1 is parked in the first learning travel, the analysis processing starts. However, in a case where the IG of the vehicle is turned off without waiting for the end of the analysis processing, the state management unit 110 performs the proposal processing together with the notification unit 180 when the IG of the vehicle 1 is turned on next time. Here, the occupant may determine whether to perform the continuous learning travel.

In addition, the map generation unit 120 may assume that the registration of the map data by the first learning travel is approved, and may execute processing up to the registration processing of registering the map during the IG-OFF period. In a case where the continuous learning travel is performed after the map is registered, even if the data on the RAM collected for the first time is lost, the map generation unit 120 can generate a map to which the feature point collected in the continuous learning travel is added or the route data is added based on the route and the feature point registered in the map, and can perform registration by overwriting the previously registered map. Alternatively, a map in which the feature points collected in the continuous learning travel and the branch route starting from the edge point 24 are registered may be generated and additionally registered separately from the previously registered map. In addition, the map to be additionally registered may cite a feature point group or a route of the previously registered map.

Note that, when a map based on the first learning travel is registered at the time of the second route calculation, the reference route referred to in the route calculation is a route registered in the map. Conversely, in a case where no map is registered, the reference route is a set route that is not registered in the map. Therefore, when generating another route to another parking position, the map generation unit may be configured to generate another route on the basis of a route registered in the map or a set route so that a reference route can be selected. Thus, when an existing route is used, the time required for route calculation can be shortened.

### Branch Learning Travel

Next, a branch learning travel will be described. The branch learning travel is a learning travel started in the middle of automatic parking. The map generation unit sets, as another parking position, a parking position when the occupant of the vehicle 1 switches automatic parking to manual driving on the way and parks at a position different from the target parking position of automatic parking. Then, another route from the start position of automatic parking to another parking position is generated, and the generated another route is registered in the map. According to this branch learning travel, when parking cannot be performed at the target parking position of automatic parking, it is possible to start learning travel on the spot, and it is not necessary to return to the parking start position and start learning travel. Therefore, it is possible to add a parking position in a short time.

Here, an example will be described in which, when the vehicle travels on the parking route illustrated in FIG. 12 by automatic parking, the driving is switched to manual driving on the way and the branch learning travel is performed. In this example, it is assumed that a complete learning travel in which the learning travel is started at the edge point 23, the vehicle is parked at the parking position 27 via the edge points 24, 25, and 26, and a map including the parking route RA is registered has been performed in the past. Then, when the occupant starts automatic parking at the edge point 23, stops the vehicle by pressing the brake while automatically traveling in accordance with the map, and switches to the manual traveling to park, it becomes the branch learning travel.

For example, in a case where the vehicle stops while automatically traveling in the section 23-24 of the parking route RA and starts manual traveling, the map generation unit 120 may set the stop position on the section 23-24 as the branch point. For example, in a case where the occupant stops the vehicle 1 at the edge point 24, the edge point 24 becomes a branch point. Alternatively, the map generation unit 120 may compare the manual parking route with the automatic parking route, determine a position where the manual parking route is divided from the automatic parking route, and use the position as a branch point. For example, as in the route RB of FIG. 13, in a case where the vehicle 1 goes straight beyond the edge point 24 after stopping on the section 23-24, stopping automatic parking, and starting manual traveling, the map generation unit 120 may set the edge point 24, which is a point at which the route is divided, as the branch point. Hereinafter, it is assumed that the branch point is the edge point 24. For example, the map generation unit 120 additionally registers a branch route starting from the branch point 24 in the map.

In the continuous learning travel described above, the vehicle 1 leaves from the first parking position and is parked at the second parking position, and the vehicle 1 does not travel on a route directly from the parking start position to the second parking position. In the manual setting, the vehicle is not parked at the second parking position in the first place. Therefore, in the continuous learning travel and the manual setting, the route for parking at the second parking position is generated on the basis of the route for parking at the first parking position. On the other hand, in the branch learning travel, since the vehicle 1 travels on a route straight from the parking start position to the second parking position, it is not necessary to generate an additional route on the basis of the existing route. Thus, the map generation unit 120 may directly register, as the branch route, the route manually traveled from the branch point 24 on the map. Alternatively, the route calculation processing of approximating the route of the learning travel and setting a route substantially along the route may be performed, and a branch route including a small number of sections may be registered in the map.

However, also in the case of the branch learning travel, as in the case of the continuous learning travel or the manual setting, a route for parking at the second parking position may be generated on the basis of the route for parking at the first parking position, and the route may be registered in the map. In short, it is not necessary to change the method of route calculation in accordance with the method of setting the second parking position. The route for parking at the second parking position may be always generated on the basis of the route for parking at the first parking position. Note that, in the case of the branch learning travel, the route for parking at the first parking position is a route registered in the map, but in the case of the continuous learning travel, the route for parking at the first parking position has been set but is not registered in the map. Therefore, when generating another route, the map generation unit generates another route on the basis of the reference route so that the reference route can be selected from a route registered in the map or a set route. Thus, when an existing route is used, the time required for route calculation can be shortened.

Note that in a case where the occupant of the vehicle 1 switches automatic parking to manual driving, notification regarding registration of another route in the map is suppressed or the notification is not performed as compared with the case where the occupant of the vehicle starts manual driving from the parking position. The reason is that in a case where automatic parking is switched to manual driving, the purpose is often to avoid oncoming vehicles and obstacles, and rarely to park at another position. Therefore, it is preferable that the state management unit 110 suppresses notification or does not make notification so as not to trouble the occupant as much as possible.

For example, when the occupant stops the vehicle 1 and then stops the automatic parking and starts the manual traveling, the addition of the parking route and the setting of the parking position should not be inquired. This is because, if the inquiry is made, unnecessary notification is performed in a case where the purpose is avoidance, and the notification bothers the occupant. Therefore, the state management unit 110 causes the notification unit 180 to output an image indicating “A route for manual parking can be registered” or the like, and starts the collection processing so that the parking position can be additionally registered when the occupant desires. The notification at the start of the manual operation may be performed only by displaying a message as text on the screen of the HMI device 20, and may not be performed by voice. In such a case, when the parking assistance device interrupts the automatic parking and starts the manual travel, the parking assistance device starts the processing of the learning travel without voice message.

In the above case, since the state management unit 110 causes the map generation unit 120 to start the processing of the learning travel without inquiring the occupant whether to add the parking position, it may be said that the processing of the learning travel is started speculatively.

In addition, when detecting that the gear position becomes P in the end point processing, the map generation unit 120 may start the processing after the analysis processing without notifying the occupant, and execute the processing in the background without requesting the approval of the occupant until the registration processing. In short, all processes including map registration may be executed speculatively. In such a case, the state management unit 110 may notify that the parking position has been added and that the last registered parking position can be deleted after the registration processing is ended or when the IG-ON is performed next time.

As described above, in a case where the parking mode is switched to manual parking during automatic parking, there are many cases where the parking mode is for other purposes such as avoiding obstacles, loading baggage, or getting off a person, rather than a case where the purpose is to add a parking position. Therefore, the state management unit 110 may perform the notification by a notification method that can be left, instead of a notification method that does not proceed without approval or an instruction.

For example, the state management unit 110 displays text such as “Do you want to register last position where manual parking is performed?” on the HMI device 20 or the like. Then, in a case where Yes is not input within 5 seconds, the map generation unit 120 may delete the map of the branch route. In this way, in a case where the occupant does not want to add a parking position, the occupant does nothing.

Further, the map generation unit 120 may add “Unapproved” to the map and hold the registration. In this case, the state management unit 110 may request approval by displaying a list of unapproved maps at the next time of manual parking. In addition, the map generation unit 120 may perform an operation of automatically deleting an unapproved map having the oldest registration date when the number of registered maps increases.

### Additional Learning Travel

Next, the additional learning travel will be described. The additional learning travel is a learning travel started after automatic parking. The map generation unit sets, as another parking position, a parking position where the vehicle 1 is parked by manual driving of the occupant after leaving a parking position at which the vehicle 1 was parked by automatic parking. Another parking position to be set by the map generation unit is different from the parking position where the vehicle 1 was parked by automatic parking. Then, another route from the parking start position of automatic parking to another parking position is generated, and the generated another route is registered in the map. In a case where there are two or more parking spaces in the garage, one parking position may be registered, and the next parking position may be registered after automatic parking is tried. At that time, according to the additional learning travel, it is not necessary to return to the parking start position and start the learning travel, so that the next parking position can be registered in a short time. In the additional learning travel, the continuous learning travel may be regarded as starting at the parking position of automatic parking instead of the parking position of the learning travel, or the branch learning travel may be regarded as starting at the parking position of automatic parking instead of in the middle of automatic parking.

The notification of the additional learning travel may be the same as the notification of the continuous learning travel. For example, in the example of FIG. 12, when the vehicle 1 automatically parks at the parking position 27, the state management unit 110 displays a message inquiring “Do you want to register another parking position?” or the like to the HMI device 20 or the like. In this case, if the occupant's answer is Yes, the state management unit 110 displays “Move vehicle and park at next parking position.” or the like on the HMI device 20 or the like to request the occupant to park manually.

In response to this, it is assumed that the occupant leaves the parking slot by manual traveling and parks at the parking position 32 as in the example of FIG. 19. In this case, the map generation unit 120 determines the second parking position 32 on the basis of manual parking by the occupant. In the case of the additional learning travel, the method of setting the branch point and the process of generating the route of the branch route may be substantially the same as those in the continuous learning travel, but the data based on the route generation is different. The data used as the basis of route generation in the case of the additional learning travel is data of automatic parking as in the case of the branch learning travel.

In the route generation after the end of the additional learning travel, a route for parking at the second parking position is generated on the basis of the positional relationship between the first parking position and the second parking position and the route for parking at the first parking position. In the case of the continuous learning travel, the route data on the memory is the route data before registration. In the case of the additional learning travel, the route data on the memory is a route registered in the map. However, since the contents of the data are the same, it is not necessary to distinguish the two.

Note that, in a case where there is an error in the vehicle control at the time of automatic parking and there is a difference between the target parking position (end point of the route) registered in the map and the actual parking position, this may be compensated during the route generation. For example, the map generation unit 120 first calculates a positional relationship between the first parking position and the second parking position from the route of the additional learning travel. The accumulation of errors is suppressed by adding the data of the difference between the actually parked position and the target parking position to the data of the positional relationship. Therefore, the storage unit 170 may store data of a difference between the actual parking position and the target parking position when automatic parking is performed in preparation for the additional learning travel. In this way, the map generation unit 120 can suppress accumulation of errors even when the additional learning travel is performed on a day different from the day of automatic parking. The description of other processing of the route calculation based on the second parking position overlaps with the description of the case of the continuous learning travel, and thus, is omitted.

The processing of the feature points of the additional learning travel may be the same as the processing of the feature points of the continuous learning travel. Note that, as an application in a case where a parking position is added by learning travel, the map generation unit 120 may exclude feature points registered in an existing map from the target of the collection processing. Alternatively, in the process of the registration processing, the map generation unit 120 may exclude the feature points registered in the existing map from the processing target among the feature points collected in the collection processing. When the number of processing targets is reduced in this manner, the processing time can be shortened.

Although the application of dividing the map into the parking route RA and the parking route RB and the application of combining the maps have been described above, in the case of the additional learning travel, the map of the branch route may be additionally registered separately from the map of the parking route RA. This is because, in the case of the additional learning travel, the branch route is often not registered, and thus it is easier to delete the map of the branch route by dividing the map.

For example, in a case where the route RA for parking at the parking position 27 and the map in which the feature points of the regions A1 to A6 are registered are first as illustrated in FIG. 16, and the route RB for parking at the parking position 32 and the maps in which the feature points of the regions A1, A2, A4, A5, A7, and A8 are registered are added as illustrated in FIG. 18, the two maps can be handled independently. In order to cope with branching, it is necessary to change the link of the existing map, but since the feature point and the like do not need to be changed, the amount of change of the map can be minimized.

In a case where the map is not separated, the feature points registered in the map extend in the range of the regions A1 to A8 in FIG. 17, and the number of feature points is larger than that when one parking route is registered. In the example of FIG. 17, the vehicle is parked in the same garage. However, in the case of the additional learning travel, there are many cases where the vehicle is temporarily parked at a completely different position outside the garage and the additional parking position is not registered. Therefore, the additionally registered feature points are often wasted.

In a case where the map is not separated and the data amount of the map is kept constant, it is necessary for the map generation unit 120 to select feature points already registered in the map and delete part of the feature points in order to register the feature points collected in the second learning travel in the map. Then, there is a disadvantage that the processing amount increases and the processing time becomes longer, or the accuracy of parking deteriorates by deleting the feature points registered in the map. In addition, in a case where the additional parking position is not registered, the added feature point becomes unnecessary, but the deleted feature point cannot be restored, so that the degradation of the accuracy continues. In a case where the map generation unit 120 separately generates a map of a branch route, disadvantages such as an increase in processing time and deterioration in accuracy do not occur in exchange for an increase in the amount of data.

The method for generating a map including a plurality of parking positions has been described so far. When automatic parking is performed using the map, a parking position is selected by some means. For example, the occupant may select the parking position at the start of automatic parking or during automatic parking, but the parking position may be prioritized in advance. In this case, since the parking assistance ECU 100 can automatically select the parking position based on the priority order, the occupant does not need to give an instruction during automatic parking. The means for determining the priority may be optional. For example, the order in which the parking positions are registered may be the priority, or the occupant may manually determine the priority. In the following example of automatic parking, priority is assigned in order of proximity from the parking start position.

### Automatic Parking Processing

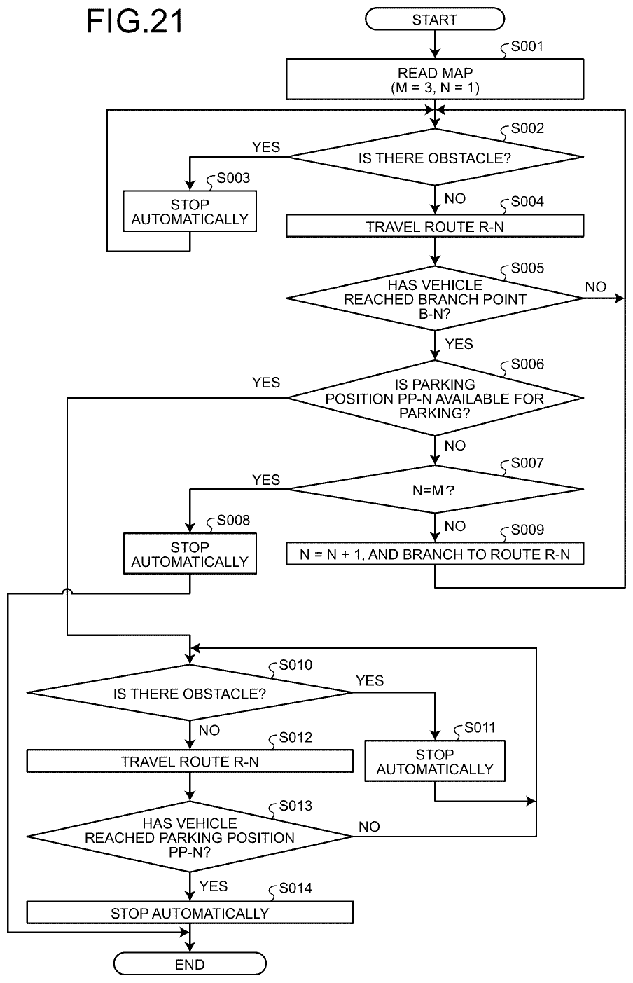

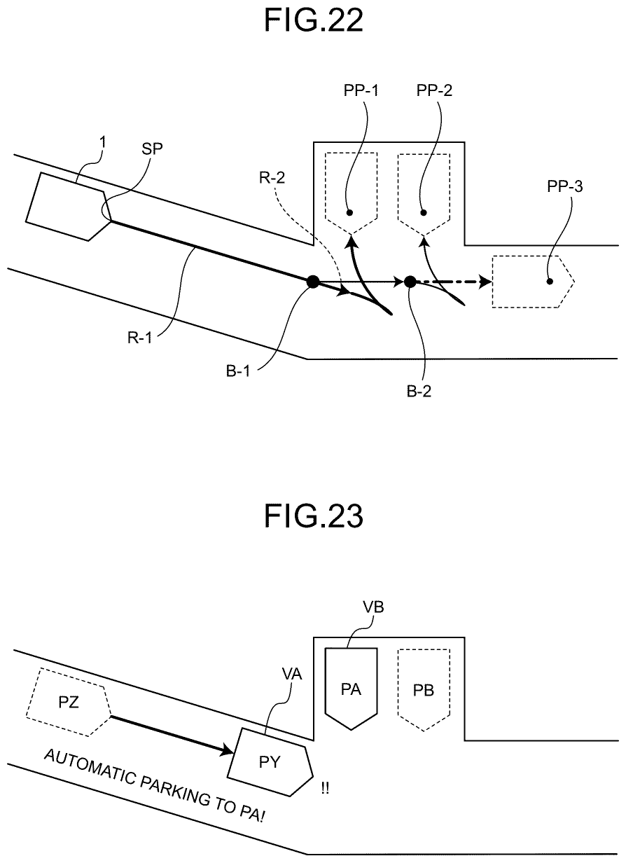

An example of processing executed by the parking assistance ECU 100 during automatic parking will be described below. FIG. 21 is a flowchart illustrating an example of processing executed by the parking assistance ECU 100 according to the embodiment during automatic parking. FIG. 22 is a diagram illustrating an example of automatic parking executed by the parking assistance ECU 100 according to the embodiment.

Hereinafter, an example of automatic parking using a map including multiple parking positions will be described as an example of processing executed by the parking assistance ECU 100 according to the embodiment. The map generated by the learning travel stores a route as illustrated in FIG. 22.

The map generated by the learning travel stores a route R-1 for parking at a parking position PP-1, a route R-2 for branching from the route R-1 at a branch point B-1 and parking at a parking position PP-2, and a route R-3 for branching from the route R-2 at a branch point B-2 and parking at a parking position PP-3.

Assuming that the number of stored routes is M, M=3 in the example of FIG. 22. In the automatic parking in the example of FIG. 22, when the vehicle travels on a route R-N (N=1 to 3), the vehicle travels with a parking position PP-N (N=1 to 3) as the target parking position. Then, in a case where the vehicle cannot be parked at the parking position PP-N (N=1 to 2) when the vehicle reaches the branch point B-N (N=1 to 2), the route is changed to N=N+1. However, in a case where parking at the parking position PP-M cannot be performed when N=M (M=3), the automatic parking is terminated by automatic stop.

The flowchart of FIG. 21 is managed by the state management unit 110. The state management unit 110 also manages parameters (M, N) used for processing. In addition, the progress of each step and the jump from step to step are determined by the state management unit 110.

First, the state management unit 110 reads a map from the storage unit 170 (step S001). The storage unit 170 can store a plurality of maps, and the state management unit 110 selects a map to be read. For example, the state management unit 110 may obtain position information of the host vehicle from the navigation device 40 via the in-vehicle LAN, compare the position information with start position coordinates of each map, and select a map having the closest start position.

In addition, the state management unit 110 sets initial values of the parameters on the basis of the information (the number of parking positions=3) recorded in the map read from the storage unit 170 (M=3, N=1).

The space recognition unit 140 constantly detects whether there is an obstacle in the traveling direction of the vehicle 1 (step S002). For example, the space recognition unit 140 detects the front on the basis of the image of a front camera 2c. The state management unit 110 determines whether there is an obstacle within a predetermined range in the traveling direction of the vehicle 1 on the basis of the detection result. The obstacle detection unit may be a sonar or a short-range radar (not illustrated).

If an obstacle is detected (step S002: Yes), the state management unit 110 instructs the travel control unit 160 to automatically stop the vehicle 1 (step S003). The vehicle 1 does not start when the obstacle is detected at the start of automatic parking, and automatically stops when the vehicle is traveling. If no obstacle is detected (step S002: No), the process proceeds to step S004.

The state management unit 110 instructs the travel control unit 160 to cause the vehicle 1 to travel along the route R-N (step S004). Even in a case where the vehicle is automatically stopped in step S003, the vehicle 1 restarts traveling when the detection of the obstacle disappears (step S002: No).

Next, the state management unit 110 determines whether the branch point B-N has been reached (step S005). If the vehicle has not reached the branch point B-N (step S005: No), the process returns to step S002 and repeats the loop of steps S002 to S005.

If the vehicle has reached the branch point B-N (step S005: Yes), the state management unit 110 determines whether the parking position PP-N is available for parking (step S006). For example, when the vehicle is at the branch point B-1, the state management unit 110 may determine that parking is possible if the space recognition unit 140 detects the left front of the vehicle 1 on the basis of the image of the left side camera 2a and all the detection points of the parking position PP-1 among the feature points registered in the map are detected.

In addition, when none of the feature points located behind the parking position PP-N is detected among the feature points registered in the map, the state management unit 110 may determine that the parking position PP-N cannot be parked.

In addition, the state management unit 110 may detect the direction of the parking position PP-N with a side sonar (not illustrated), and determine that the parking position PP-N is available for parking if the detected distance to the closest obstacle is a distance corresponding to a back wall of the parking position PP-N. Alternatively, the state management unit 110 may temporarily stop the vehicle 1 at the branch point B-N, and inquire the occupant whether the parking position PP-N can be parked to input.

If parking is not possible (step S006: No), the state management unit 110 determines whether the route on which the vehicle is traveling is the last route registered in the map (step S007). In the example of FIG. 21, since the number M of routes is 3, if the route is not the last route (N=3), the process proceeds to step S009. If the vehicle is traveling on the last route R-3, the process proceeds to step S008.

Step S008 is a process in a case where parking cannot be performed at any of the parking positions registered in the map. The state management unit 110 instructs the travel control unit 160 to stop the vehicle 1 (step S008), and ends this process.

For example, notification processing may be added to step S008. In this case, the state management unit 110 may notify the occupant by displaying “Since parking cannot be performed at any of the registered parking positions, automatic parking is terminated.” or the like on the HMI device 20 or the like. In addition, the state management unit 110 may further add a step of confirming that the gear position becomes P to ensure that the vehicle 1 does not move after the automatic parking is ended.

If the route is not the last route in step S007 (step S007: No), the state management unit 110 sets N=N+1 and changes the traveling route from the route R-N to the route R−N+1 (step S009). Step S009 is a process for changing the route and continuing automatic parking.

For example, when the route on which the vehicle is traveling is the route R-1 (N=1), the state management unit 110 branches from the route R-1 to the route R-2, and when the route on which the vehicle is traveling is the route R-2 (N=2), the state management unit branches from the route R-2 to the route R-3. Upon branching, the process returns to step S002. Steps S002 to S009 are a loop of processing corresponding to a case where branching is repeated, and there is a possibility that branching is performed up to two times on this map.

If parking is possible in step S006 (step S006: Yes), the state management unit 110 determines whether there is an obstacle within a predetermined range in the traveling direction of the vehicle (step S010).

If there is an obstacle in the traveling direction (S010: Yes), the state management unit 110 instructs the travel control unit 160 to automatically stop the vehicle 1 (step S011). When the obstacle in the traveling direction disappears (step S010: No), the state management unit 110 instructs the travel control unit 160 to restart the travel of the route R-N (step S012).

In addition, the state management unit 110 determines whether the vehicle 1 has reached the parking position PP-N (step S013). When the vehicle does not reach the parking position PP-N (step S013: No), the state management unit 110 continues traveling until the vehicle reaches the parking position PP-N.

When the parking position PP-N is reached in step S013 (step S013: Yes), the state management unit 110 automatically stops the vehicle 1 (step S014), and ends the control of automatic parking. Note that the state management unit 110 may further add a step of operating the parking brake before the end of the control to ensure that the vehicle 1 does not move after the end of automatic parking.

In the flowchart of FIG. 21, a process of automatically stopping the vehicle 1 when an obstacle is detected is inserted. However, even when the occupant operates the brake, the state management unit 110 may perform processing in the same manner as in the case of detecting an obstacle. The state management unit 110 may resume automatic parking of the vehicle 1 when the occupant releases the brake.

Note that, in FIG. 21, an example has been described in which, when parking cannot be performed at any of the parking positions registered in the map, the state management unit 110 instructs the travel control unit 160 to stop the vehicle 1 and end automatic parking. However, at that time, the state management unit 110 may display “You cannot park at any of the registered parking locations, so please park manually.” or the like on the HMI device 20 or the like via the notification unit 180 to urge the occupant to perform manual parking. Further, the notification unit (the state management unit 110 and the notification unit 180) may further notify the occupant that the parking position where the vehicle is manually parked is registered in the map. The notification unit includes the state management unit 110 and the notification unit 180, and may include the HMI device 20. In a case where the occupant performs manual parking in response to this notification, the vehicle is subjected to the branch learning travel.

The notification related to the additional registration of the parking position is not limited to the case where the vehicle cannot be parked at all the parking positions. In the case of FIG. 22, the notification may be given before the vehicle gets stuck ahead of the branch point B-2. For example, in a case where the occupant of the vehicle stops the vehicle or a case the vehicle cannot be parked at the parking position registered in the map, the notification unit proposes to switch automatic parking to manual driving and park the vehicle to the occupant of the vehicle. In this way, the occupant can start the branch learning travel from an optional position at an optional time point without waiting for the automatic parking to be stopped. At the time of the suggestion, the occupant may be notified that the parking position can be additionally registered by manual driving. Accordingly, even an occupant who is unfamiliar with the parking assistance function can additionally register a parking position.

For example, in a case where there are parking positions for a plurality of vehicles in the garage, it is considered that the occupant makes the same determination earlier before the parking assistance device determines that parking cannot be performed at all the parking positions and causes automatic stop. Therefore, for example, from the time point when it is determined that parking at the first target parking position cannot be performed, a button for selecting parking by switching to manual driving is displayed. In addition, since there is a case where it is determined that the occupant cannot park before the space recognition unit 140 starts detecting the parking position, the display of the button may be started when the occupant stops the vehicle. In this way, since the occupant can immediately start manual driving, the parking position can be added and registered smoothly.

Means for instructing the start of manual parking is not limited to a button, and may be an operation of a brake, a steering wheel, a blinker, or a hazard lamp. In addition, it is not always necessary to stop the vehicle when starting manual parking. For example, in a case where the occupant operates the steering wheel during automatic parking, leaves the parking route, and parks at another position, traveling from the position where the operation of the steering wheel is started to the parking position is regarded as the branch learning travel, and the parking route may be additionally registered so that the additionally registered parking route can be used when automatic parking is performed next time.

From here, control of automatic parking will be described focusing on processing for handling data. For example, data processing of the automatic parking may be expressed as follows. As illustrated in FIG. 14 described above, the route data stored in the map is an aggregate of section data. The state management unit 110 reads the section data and instructs the travel control unit 160 to travel on the basis of the values of the steering angle and the travel distance recorded therein. The state management unit 110 repeats this for each section to travel along the recorded parking route.

For example, the state management unit 110 reads section data using a pointer. The section data includes a link indicating a head address of the next section data. By reading the next section data following this link, the state management unit 110 can read data of a series of parking routes.

In such a configuration, the branching processing corresponds to a process of changing a link to be followed. For example, it is assumed that the section data includes a link indicating a head address of the next section data and a link indicating a head address of the first section data of the branch route. When the state management unit 110 reads the section data following the latter link, it is possible to obtain a steering angle in a case where the vehicle travels on the branch route and a value of a travel distance of the section.

Then, the state management unit 110 follows links to the next section one after another, and when the link “0” indicating the end point is reached, this is the final section. The state management unit 110 stops the vehicle at the point of time when the vehicle has run through the last section, and terminates the automatic parking.

Here, at the branch point, the state management unit 110 selects whether to branch the parking position connected to the route depending on whether parking is possible. Therefore, it may be said that the state management unit 110 functions as a route selection unit to select a route at the branch point. Further, since the space recognition unit 140 determines whether parking is possible, the space recognition unit 140 may be included in a route selection unit.

In summary, an embodiment of the present disclosure is a parking assistance device including: a map generation unit that registers a map including a route from a parking start position to a parking position during learning travel; and a travel control unit that causes a vehicle to perform autonomous travel based on the map during automatic parking, in which the map includes multiple routes branching from one parking start position in the middle to multiple parking positions, and the parking assistance device further includes a route selection unit that selects a route on which the vehicle is to travel from among the multiple routes during automatic parking. By using such a parking assistance device, even if a parking position scheduled at the start of automatic parking is blocked, it is possible to change the route on the way and park at another parking position by the function of the route selection unit.

Note that the route selection unit may detect the parking position or the parking route when the vehicle approaches the branch point, and select the route in accordance with the detection result. In this case, the vehicle automatically selects a vacant parking position for automatic parking, and thus the occupant does not need to instruct automatic parking. For example, the space recognition unit 140 analyzes the movement parallax of the image of the parking space when approaching the parking position. In a case where there is a larger parallax than in a case where the floor surface of the parking space is reflected, the space recognition unit 140 may determine that parking is impossible because the floor surface is not visible, and cause the route a branch route leading to another parking position.

For example, the route selection unit may select a route in accordance with the detection result of the image processor 130. Specifically, the image processor 130 detects feature points registered in the map and located at the back of the parking space or on the floor of the parking space. In a case where the corresponding feature point is not detected, the image processor 130 may determine that parking is impossible because the parking space is not visible, and may cause the branch route to branch to another parking position.

For example, the route selection unit may select a route in accordance with a detection result of an obstacle detection device such as sonar or radar. Specifically, the obstacle detection device detects whether there is an obstacle in the direction of the parking position. In a case where the distance to the detected obstacle is shorter than the distance to the parking position, the obstacle detection device may determine that parking is impossible due to the presence of the obstacle, and cause the route to a branch route leading to another parking position.

The route selection unit may select a route in accordance with an instruction of the occupant. In other words, when the vehicle approaches the branch point, the route selection unit makes an inquiry about the parking position to the occupant of the vehicle, and selects the route on which the vehicle is to travel, in accordance with the response of the occupant. Thus, the user interface that allows the occupant to select the parking route may be the route selection unit. In this way, the parking position can be changed with the preference or convenience of the occupant. Further, when the occupant selects the parking position, it is not necessary to detect the parking position, so that the price of the parking assistance device can be reduced.

For example, the state management unit 110 may stop the vehicle 1 at the branch point and output a voice message such as “Park in left parking position? Or go straight?” to the HMI device 20 or the like. In this case, the state management unit 110 may select a route by receiving a press of a button displayed on the touch panel from an occupant. Alternatively, a button for selecting a branch may be displayed when the vehicle is caused to travel, the vehicle may is branched when the button is pressed up to the branch point, and the vehicle may not be branched unless the button is pressed.

In addition, the state management unit 110 may notify the occupant of a result of selecting a parking route by a device such as the space recognition unit 140 via the notification unit 180. Further, the state management unit 110 may allow the occupant to change the route selection in a case where the notification result is different from the determination of the occupant.

For example, consider a case where the occupant feels “There is no problem in the left parking position, and it is desired to park in the left parking position.” when the state management unit 110 notifies that “Pass through the left parking position and go straight.” or the like. In this case, the occupant instructs the route change by slightly turning the steering wheel to the left, for example. Then, when the state management unit 110 accepts the steering wheel operation by the occupant, the determination may be reversed, a course on the left side may be selected, and at the same time, “Park to the left” may be notified. At that time, the state management unit 110 may notify that the instruction has been received by vibrating the handle or the like. This can prevent the occupant from steering more than necessary.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A parking assistance device comprising processing circuitry connected to a memory and configured to:
register, during learning travel, a map including multiple routes from one parking start position to multiple parking positions;
cause, during automatic parking, a vehicle to perform autonomous travel based on the map; and
select, during automatic parking, a route on which the vehicle is to travel from among the multiple routes.

2. The parking assistance device according to claim 1, wherein the processing circuitry is configured to, in a case where a different parking position other than the parking position is set after the learning travel,
generate a different route from the parking start position of the learning travel to the different parking position, and
register the generated different route in the map.

3. The parking assistance device according to claim 2, wherein the processing circuitry is configured to set, as the different parking position, a parking position at which an occupant of the vehicle drives and parks the vehicle by manual driving from a parking position at which the vehicle is parked in the learning travel.

4. The parking assistance device according to claim 2, wherein the processing circuitry is configured to set, as the different parking position, a parking position at which an occupant of the vehicle switches the automatic parking to manual driving and drives and parks the vehicle by the manual driving.

5. The parking assistance device according to claim 2, wherein the processing circuitry is configured to set, as the different parking position, a parking position at which an occupant of the vehicle drives and parks the vehicle by manual driving from a parking position at which the vehicle is parked in the automatic parking.

6. The parking assistance device according to claim 2, wherein the processing circuitry is configured to
collect detection information around a vehicle during the learning travel, and
set the different parking position based on the detection information when the vehicle is parked in the learning travel.

7. The parking assistance device according to claim 2, wherein the processing circuitry is configured to, when the vehicle is parked in the learning travel,
propose an occupant of the vehicle to add a parking position, and
set the different parking position based on an operation or approval of the occupant.

8. The parking assistance device according to claim 7, wherein the processing circuitry is configured to
collect detection information around a vehicle during the learning travel,
set a parking position candidate based on the detection information, and
propose the parking position candidate to the occupant of the vehicle.

9. The parking assistance device according to claim 2, wherein the processing circuitry is configured to perform the generation of the different route on the basis of a reference route being a route registered in the map or a route having been set.

10. The parking assistance device according to claim 9, wherein
data of each route is an aggregate of data of sections constituting the route, and
the processing circuitry is configured to, when generating the different route based on the reference route, generate data of sections of the different route by copying, processing, or sharing data of reference sections.

11. The parking assistance device according to claim 10, wherein
the data of the route includes a link serving to jump to data of the different route, and
the link jumps to
data of the different route contained in a same map as a map containing the route, or
data of the different route contained in a different map other than the map containing the route.

12. The parking assistance device according to claim 2, wherein the processing circuitry is configured to
perform notification related to registering of the different route in the map, and,
in a case where an occupant of the vehicle switches the automatic parking to manual driving, suppress the notification or not to perform the notification as compared with a case where the occupant of the vehicle starts manual driving from the parking position.

13. The parking assistance device according to claim 2, wherein the processing circuitry is configured to
collect information on feature points around the vehicle during the learning travel, and,
when the different route is registered in the map, register, in the map, at least information on a feature point located near the different parking position.

14. The parking assistance device according to claim 2, wherein the processing circuitry is configured to
collect information on feature points around the vehicle when an occupant of the vehicle drives the vehicle by manual driving after the learning travel, and,
when the different route is registered in the map, register, in the map, at least information on a feature point located near the different parking position.

15. The parking assistance device according to claim 1, wherein
the route includes a branch point, and
the processing circuitry is configured to
inquire of an occupant of the vehicle about a parking position when the vehicle approaches the branch point, and
select a route on which the vehicle is to travel in accordance with a response of the occupant.

16. The parking assistance device according to claim 1, wherein
the route includes a branch point, and
the processing circuitry is configured to
detect a parking position or a parking route when the vehicle approaches the branch point, and
select a route on which the vehicle is to travel in accordance with a result of the detection.

17. The parking assistance device according to claim 1, wherein the processing circuitry is configured to, in a case where an occupant of the vehicle stops the vehicle, or in a case where the vehicle cannot be parked at a parking position registered in the map, propose, to the occupant of the vehicle, that the automatic parking is switched to manual driving and parking.

18. The parking assistance device according to claim 4, wherein
the automatic parking is switched to manual driving when the occupant of the vehicle performs a predetermined operation, and
the predetermined operation is an operation of a predetermined button, or an operation of a brake, a steering wheel, a blinker, or a hazard lamp.
